(19) United States
(12) Patent Application Publication
(10) Pub. No.: US 2026/0158609 A1
(43) Pub. Date: Jun. 11, 2026

(54) Method for Machining Glasses Lenses, and Workpiece Holding Head for Optical Workpieces such as Glasses Lenses

(71) Applicant: Satisloh AG, Baar (CH)

(72) Inventors: Holger Schäfer, Weilmünster (DE); Johannes Claar, Ebsdorfergrund (DE); Gregor Pavel, Hüttenberg (DE); Tobias Gelada, Schöffengrund (DE)

(21) Appl. No.: 18/706,098

(22) PCT Filed: Nov. 1, 2022
(86) PCT No.: PCT/EP2022/080468

§ 371 Date: Apr. 30, 2024

(30) Foreign Application Priority Data
Nov. 1, 2021 (DE) 10 2021 005 399.0

(51) Int. Cl. B24B 13/005; B24B 13/00; B24B 41/06

(52) U.S. Cl. CPC B24B 13/0055; B24B 13/0031; B24B 41/061

(57) ABSTRACT

A workpiece holding head has a housing, in/on which a holding arrangement and a support arrangement for an optical workpiece are accommodated. The holding arrangement has a rubber-elastic sealing sleeve which is mounted on the housing and which has a circumferential sealing lip for contact with the workpiece. The sealing lip surrounds an opening on the housing, to which opening a vacuum can be applied. The support arrangement has a plurality of longitudinally displaceable pins that can be placed against the workpiece and that can be fixed with respect to the housing by a clamping mechanism. Each of the pins is assigned a pneumatically actuated piston-cylinder arrangement, which can move the pin outwards with respect to the housing into a support position for the workpiece or, conversely, inwards into a park position that avoids workpiece contact, depending on the pneumatic actuation.

### TECHNICAL FIELD

The present invention relates generally to a method for processing spectacle lenses by machining. In particular, the invention relates to a method for processing spectacle lenses of plastic by machining, for example polycarbonate, CR39 or so-called “high index” materials such as practiced on a large scale in so-called “RX workshops”, i.e. production facilities for production of individual spectacle lenses according to prescription. Moreover, the invention relates to a workpiece holding head for optical workpieces, such as spectacle lenses, which can be used particularly in such a method.

The method described here as well as the workpiece holding head described here are very well suited to, for example, use in combination with or in a method for processing by machining of, in particular, spectacle lenses of plastic, such as described in earlier German patent application DE 10 2021 004 831.8 of the same applicant and/or use in conjunction with a workpiece retainer such as described in earlier German patent application DE 10 2021 005 202.1 of the same applicant. With respect to details of the earlier method and device express reference is made at this point first of all to the aforesaid earlier German patent applications.

### PRIOR ART

In the first above-mentioned earlier German patent application it is already described in detail which process steps currently are usually undertaken in RX workshops in the industrial production of spectacle lenses, so that the usual procedure need be only very briefly outlined at this point. The starting product in the industrial production of spectacle lenses is a semi-finished spectacle lens blank, also termed “blank”, which has an optically effective surface already processed to finished state and provided by injection molding or preshaped in some other way and which is to be processed at its other optically effective surface and at the edge between the optically effective surfaces to form a finished spectacle lens.

As is explained in this earlier German patent application in detail by way of FIGS. 16 and 17 and with citation of the respectively relevant prior art—to which reference may again be made here—in that case the following process steps are usually carried out in sequential succession: a) so-called “blocking” of the spectacle lens blank at a blocking member with the sub-steps of establishing position as well as positioning and fixing on the blocking member, b) so-called “generating” with the sub-steps of preliminary edge processing and surface processing, c) polishing and d) marking, wherein the process steps b) to d) are performed at the blocked workpiece, then e) so-called “deblocking” of the workpiece from the blocking member, f) coating and g) so-called “edging” with the sub-steps of recognizing position as well as final processing of edge shape. In the process steps b) to d) the blocking member represents a retainer or machine interface for the processing of the workpiece so as to be able to rotationally drive the workpiece during processing and to reliably hold it in an always defined position and orientation in three dimensions.

The previously known process chain outlined to that extent includes by the above process steps of a) blocking and e) deblocking two sequences which represent necessary auxiliary procedures, but which do not themselves enhance the value of the produced spectacle lens. A process chain which manages without these auxiliary procedures would thus be desirable. In particular, for increasing efficiency and also for ecological considerations it was already proposed in the prior art to work “blocklessly” in the production of the optically effective surfaces of spectacle lenses (see, for example, WO 2015/059007 A1, U.S. Pat. No. 9,969,051 B2, DE 10 2016 112 999 A1, DE 10 2004 016 445 B4).

However, the concepts disclosed therein provide, in the surface processing of the spectacle lenses, only inadequate support of the workpiece at the counterpart surface and/or function with mechanically applied holding forces engaging at the workpiece edge or in the workpiece center. Both—inadequate support and mechanically applied holding forces—involve the risk of undesired lens deformations which ultimately can detract from processing quality. For details with respect thereto see, in particular, the discussion of this prior art in the two afore-mentioned earlier German patent applications of the applicant.

In order to address this issue, there is proposed in earlier German patent application DE 10 2021 004 831.8 primarily a method for processing of, especially, spectacle lenses of plastic by machining in which a semi-finished product with predetermined surface geometries at front side and rear side as well as a contoured edge of predetermined edge thickness therebetween is formed from a blank and which comprises the following main steps: i) providing the blank, which is to be processed at least at the rear side and edge and which has a blank thickness; ii) block-free retention of the blank for supported holding at the rear side; iii) processing the blank at the front side by a first tool for formation of an encircling geometric shape with a depth greater than or equal to the edge thickness of the semi-finished product to be formed, wherein a circumferential area defining the contoured edge of the semi-finished product to be formed remains at the workpiece; iv) receiving the workpiece for supported holding at the front side; and v) processing the workpiece at the rear side by at least one second tool for formation of the semi-finished product with the predetermined surface geometry at the rear side.

It is thus proposed in the main step iii) of the method to bring forward or to advance in time a processing of the contoured edge of the semi-finished product to be formed—whether in the sense of preliminary edging or final edging of the workpiece—and in fact starting from the front side of the blank, which in that case is blocklessly retained at the rear side in accordance with the main step ii), before the workpiece after retention at its front side in main step iv) is surface-processed at its rear side in accordance with the main step v). In any event, after the main step v) the generated semi-finished product is then completely separated from excess radially outer blank material which drops away as an annular piece or in segments of a ring.

This basically two-stage procedure—initially (first) workpiece retention at the rear side and processing at the front side of the workpiece near the blank edge and thereafter (second) retention at the front side and processing at the rear side of the workpiece also in the center—with the provided sequence of individual method steps offers advantages, especially when plastics-material spectacle lenses are processed by machining, with respect to primarily the holding of the workpiece, this being important for process reliability, during the actual edge (preliminary) processing as well as propping-up or supporting, which is relevant to processing quality, of the workpiece during the actual surface processing. These effects and advantages are discussed in detail in earlier German patent application DE 10 2021 004 831.8, to which at this point reference may be made.

For the second stage, in particular, of the above procedure, i.e. (second) retention of the workpiece at the front side and processing of the rear side also in the center, there is disclosed in the second above-mentioned earlier German patent application DE 10 2021 005 202.1 with regard to device a retainer for the processing of optical workpieces each with two workpiece surfaces and a workpiece edge therebetween, which comprises a holding arrangement as well as a support arrangement for the workpiece. In that case, a rubber-elastic membrane mounted on a housing has a retaining section, on the outer side of which the workpiece can be placed over an area by one workpiece surface. The membrane together with the housing bounds a chamber in which a plurality of separately longitudinally displaceable pins of the support arrangement is received. The pins can each be brought by a pin end into contact with an inner side of the retaining section of the membrane and selectively fixed relative to one another against longitudinal displacement with respect to the housing by a clamping mechanism or the like so as to firmly support the retaining section in accordance with a geometry of the workpiece held by the holding arrangement.

In this retainer the holding arrangement for the workpiece is provided in or at the retaining section of the membrane and is capable of holding the workpiece without engaging the workpiece edge. With respect to, in particular, readily controllable release of the workpiece from the retainer in the process activity the holding arrangement in or at the retaining section of the rubber-elastic membrane can for that purpose function with, for example, the operating principle of “vacuum”. In that case a vacuum can be applied to the chamber in the housing, while a perforation as a component of the holding arrangement is formed in the retaining section of the rubber-elastic membrane so that a vacuum applied to the chamber is present by way of the perforation on the outer side of the retaining section of the rubber-elastic membrane for holding a workpiece to be processed.

As explained in detail in earlier German patent application DE 10 2021 005 202.1, to which reference may be made at this point, the thus-configured retainer is capable of supporting and holding optical workpieces such as spectacle lenses for workpiece processing in a way which is more reliable in terms of processing as well as without workpiece deformations detracting from processing quality, as a result of which this retainer is tailored for use in a manufacturing process chain managing in entirely block-free manner, as described in, for example, earlier German patent application DE 10 2021 004 831.8. In particular, for the first stage of the above block-free procedure, i.e. (first) workpiece retention at the rear side and processing at the front side of the workpiece near the blank edge, in terms of device there is, however, also a need for a workpiece holding head of especially suitable construction, this being a subject of the present invention. In this connection, for example, documents WO 2009/135689 A1 and WO 2016/058676 A1 additionally disclose previously known solutions for workpiece holding heads at devices for the blocking of spectacle lenses (called “blocker” for short) with use of blocking members.

Thus, there is known from document WO 2009/135689 A1 (FIGS. 7 and 8) a lens clamping unit in a blocker which has a suction lip for sucking a spectacle lens, which surrounds a pin relief adaptable to a contact surface of the spectacle lens and selectively able to be clamped so as to support the spectacle lens at this contact surface over the whole area as far as possible. A centrally mounted expansion mandrel is provided for clamping the pin relief and is axially displaceable by way of a pneumatic stroke cylinder. The stroke cylinder when loaded with pressure produces an axial movement of the conical expansion mandrel, which in turn exerts a radially outwardly directed force on the pins of the pin relief. Since all pins are guided with tight packing in a sleeve, this clamping force is transferred from pin to pin. As a result, the pins jam in the sleeve and are axially immovable. In the unclamped state the pins are displaced downwardly merely by the intrinsic weight thereof and can lay themselves against the contact surface of the spectacle lens.

Further, there can be inferred from document WO 2016/058676 A1 (FIGS. 4 and 5), which forms the preamble portion of claim 7, a holding head for spectacle lenses which in or at a housing has, apart from a suction device with an annular elastic sucker lip for holding a spectacle lens by sub-atmospheric pressure, a counter-bearing arrangement for supporting a spectacle lens, which is held at the holding head, in its oriented position. The counter-bearing arrangement has pressure pins which extend parallel to a blocker axis and are arranged to be distributed around this and the sucker lip and which are longitudinally displaceable with respect to the holding head under the influence of gravitational force so as to each come into contact with the spectacle lens by an end projecting from the holding head through an associated bore in the housing. In addition, the pressure pins are fixable in the respective axial relative setting thereof with respect to the holding head. For that purpose, the pressure pins are received in parallel arrangement with a plurality of cylindrical pins in an annular space, which is formed between a cylinder sleeve and a bearing sleeve, of the holding head, wherein provided for axial fixing of the pressure pins is a pneumatic drive by which a wedge can be driven or pushed through a cut-out in the cylinder housing in a direction transverse to the blocker axis between adjacent cylinder pins, which as a result leads to a frictional clamping of the pressure pins.

However, the afore-described known workpiece holding heads are restricted with respect to the possibilities of use thereof to vertical arrangements as is usual in blockers due to the transiently liquid blocking materials and to that extent are not usable in flexible manner.

Finally, a further aspect of the present invention is how without use of a blocking member it can be ensured in an efficient process chain for processing of spectacle lenses by machining that the position and orientation of the workpiece in three dimensions are always unambiguously known. In that regard, it is to be taken into consideration that spectacle lens blanks do not necessarily have to be rotationally symmetrical workpieces; rather, these can also have, particularly at the preshaped front side, surface geometries differing from spherical or flat geometries, for example toroidal surface geometries.

There are also attempts in the spectacles industry to divide up so-called “freeform surfaces” on the front side and rear side of the spectacle lenses so that a spectacle lens blank as starting product of the process chain in question can already have a comparatively complex asymmetrical geometry at the front side. Particularly in the case of such an approach it is obviously very important to ensure that the surface geometry, which is to be generated, at the rear side is generated with respect to its location, i.e. position in three dimensions, and also with respect to its position, i.e. orientation in three dimensions, to match the surface geometry of the front side so as to achieve the desired optical effect. In that regard, this happens only when position and orientation of the entire workpiece in three dimensions are unambiguously defined.

### OBJECT

By comparison with the prior art outlined in that respect the invention has in the first place the object of creating a simplest possible method for processing of spectacle lenses by machining which without use of a blocking member addresses the above-described problems and, in particular, enables workpiece processing reliably in terms of process and in an efficient manner. Moreover, the object of the invention include provision of a workpiece holding head for optical workpieces, such as spectacle lenses, which is very flexibly usable in, in particular, the above method—and also separately therefrom—and is equally suitable for holding and supporting workpiece blanks, partly processed semi-finished products and workpieces processed to finished state in the optical industry, particularly the spectacles industry.

### ILLUSTRATION OF THE INVENTION

These objects are fulfilled by a method for the processing of spectacle lenses by machining with the method steps according to claim 1 and a workpiece holding head for optical workpieces, such as spectacle lenses, with the features of claim 7. Advantageous or expedient embodiments and developments of the invention are the subject of the dependent claims.

According to the invention a method for processing spectacle lenses by machining, in which starting from a blank a semi-finished product with predetermined surface geometries at a front side and a rear side remote therefrom and with an edge between the front side and the rear side is formed, comprises the following main steps taking place in the indicated sequence; i) providing the blank which can already have the predetermined surface geometry at the front side and is to be processed at least at the rear side; ii) fixing and determining location and position of the blank in three dimensions; iii) block-free retention of the blank at the rear side with consideration of the location and position data, which were determined in step ii), by a workpiece holding head, which is arranged to be positionable in defined manner in three dimensions, for supported holding of the workpiece; iv) measuring the blank, which is held by the workpiece holding head, at the front side for detection of the front side geometry; v) direct transfer of the workpiece from the workpiece holding head to a workpiece retainer, which is arranged to be positionable in position and angle in defined manner, for block-free retention of the workpiece at the front side with consideration of the front side geometry data detected in step iv) and for supported holding of the workpiece; and vi) processing the workpiece at the rear side by at least one tool for forming the semi-finished product with the predetermined surface geometry at the rear side; wherein the workpiece between steps iii) and v) is held without interruption at the workpiece holding head so that location and position of the workpiece in three dimensions are always clearly defined.

In other words, the workpiece to be processed is “taken in hand” from the workpiece holding head in method step iii) and, in fact, from a position and with an orientation in three dimensions which is known in accordance with method step ii), and “put down again” only when the workpiece in method step v) is transferred to the workpiece retainer, for example of a generator. In the interim the workpiece from the workpiece holding head is “not put down”, so that position and orientation of the workpiece in three dimensions are always unambiguously defined. Only after transfer of the workpiece to the workpiece retainer, for example the generator in step v), does the “responsibility” and control with respect to position and orientation of the workpiece lie thereat. Thus, according to the invention the workpiece holding head quasi “takes over” the functions of the blocking member in the prior art in a defined segment of the method for processing of spectacle lens by machining, but without the necessity of use of a blocking member and consequently without the disadvantages connected therewith.

Whereas the “responsibility” and control with respect to position and orientation of the workpiece between the method steps iii) and v) lie with the device, which is capable of positioning in three-dimensionally defined manner the workpiece holding head carrying the workpiece—for example, in the case of a 6-axis articulated arm robot as an example for a multi-axis robot or any other handling device with corresponding positioning possibilities in three dimensions—the measuring of the workpiece, which is held by the workpiece holding head, at the front side is carried out as a single obligatory method step iv). With the data then detected about the front side geometry it is possible, for example, to obtain a surface normal to the—so-called in the prior art—“blocking point” of the workpiece, which in method step v) enables transfer with defined positioning to the workpiece retainer for processing of the workpiece at the rear side. In that case, known blocking techniques can also be “substituted” or realized by other measures such as, for example, in the prior art a blocking with decentration, thus displacement of the workpiece or prismatic tilting of the workpiece.

Advantageously, further optional manipulations or processing at the accessible front side of the workpiece can be carried out in the method phase between the method steps iii) and v), in which the workpiece holding head “fixes” the workpiece at the rear side thereof. For example, holes can be drilled in the front side, markings can be applied to the front side by, for example, a laser, a (protective) foil, a (protective) lacquer or the like can be applied to the front side, etc., for later spectacle lens processing or fastening.

Since in this method phase the workpiece constantly remains at the workpiece holding head there is in production also reduction of sources of error, which would be possible in the prior art, for example during transport of a blank, which is blocked on a blocking member, from the blocker to the generator, such as by removal and exchange of blocked blanks from the prescription box or job tray. The method according to the invention thus also makes a contribution to process reliability in the processing of spectacle lenses by machining.

Not least, a considerable increase in throughput and efficiency during processing of spectacle lenses by machining is achieved with the method according to the invention in the sense of an “intelligent” automation by comparison with the conventional prior art, because the time-consuming and error-susceptible steps of actual connection of the blank with a blocking member (filling with “alloy”, thus a metallic alloy, or glueing by a blocking material) and actual detaching of the semi-finished product from the blocking member (for example, deblocking by water under high pressure) are entirely eliminated.

In this connection it is additionally to be noted that in the prior art, now as before, blocking is very much by “alloy”. Before a “freshly” blocked spectacle lens blank may be processed in the generator this pairing must wait for at least 45 minutes in order to be able to cool down to room temperature. This is “lost” waiting time at least at the time of start of production. However, it is also a source of error when an operative manually places a still too hot blocked spectacle lens blank in a generator for processing. During processing in the generator the blank cools down under the feed of cooling lubricant and deforms, so that undesired optical functional deviations and waste can occur. Such dead times and sources of error are avoided by the method according to the invention.

In an optional, although preferred, method step there can be carried out in terms of time between the step iv) of measuring the blank and the step v) of direct transfer of the workpiece from the workpiece holding head to the workpiece retainer a processing step vii) in which the blank held at the workpiece holding head is processed so that a circumferential area defining a contoured edge of the semi-finished product to be formed is left at the workpiece. In particular, in the processing step vii) the blank can be processed at the front side by a tool so as to produce an encircling groove or step with a depth greater than or equal to an edge thickness of the semi-finished product to be formed and smaller than a blank thickness, or an encircling plunge cut which has at least in part a depth equal to the blank thickness.

Processing of the contoured edge of the semi-finished product to be formed—whether in the sense of preliminary edging or edging to finished state of the workpiece—is thus advantageously brought forward or advanced in time and, in fact, starting from the front side of the blank, which is in that case blocklessly retained at the rear side in accordance with main step iii), before the workpiece after retention at its front side in the main step v) is surface-processed at its rear side in accordance with main step vi). In any event, after the main step vi) the generated semi-finished product is then completely separated from excess, radially outer blank material, which in the main step vi) drops off as an annular member or in segments of a ring. Further details and advantageous effects of such a method enhancement are described in detail in earlier German patent application DE 10 2021 004 831.8 of the same applicant, to which express reference may here be made once more.

Moreover, in a preferred embodiment of the method the workpiece can in in terms of time after the processing step vii) and before the step v) of direct transfer of the workpiece from the workpiece holding head to the workpiece retainer again be measured at the front side so as to check location and position of the workpiece at the workpiece holding head. This fresh measuring, which can be carried out by contact or optically by measuring devices known per se, particularly serves the purpose of ensuring that undesired displacement or turning of the workpiece on the workpiece holding head does not happen in the optional processing step vii) or the purpose of undertaking, in accordance with a possibly established linear and/or rotational shift of the workpiece on the workpiece holding head, a correction of front side geometry data which may be required before the workpiece is transferred to the workpiece retainer of the generator. However, these quality-ensuring measures, which ultimately increase workpiece throughput times, may also be redundant in the case of a stably running process.

In a further preferred method embodiment it can additionally be provided in the step ii) of fixing and determining location and position of the blank in three dimensions to geometrically center the blank after deposit on a deposit surface so as to define the location of the blank, whereupon the blank is checked by an optical measuring system with respect to markings so as to determine the position of the blank. In principle, it is, in fact, possible to operate here without geometric centering of the blank and for fixing and determining location and position of the blank in three dimensions to provide, for example, simple deposit of the blank with subsequent measurement, although this complicates measuring and is accordingly less preferred. Moreover, instead of checking the blank with respect to markings, measurement-based determination of the optical properties of the blank can be carried out, from which a conclusion about location and position of the blank in three dimensions can then be made. However, this is more complicated and accordingly less preferred.

Measurement of the blank in the step iv) or after the optional processing step vii) in order to detect the front side geometry of the blank absolutely and/or the relative position and orientation thereof in three dimensions can in principle also be carried out optically. However, particularly with respect to an economic detection process which is as independent as possible from the respective ambient conditions and is reliable in terms of process it is preferred if in the step iv) of measuring the blank the blank held by the workpiece holding head is scanned by contact so as to detect the front side geometry and/or after the processing step vii) the workpiece held by the workpiece holding head is scanned by contact so as to check location and position of the workpiece at the workpiece holding head.

According to a further aspect of the present invention a workpiece holding head for optical workpieces, such as spectacle lenses, which each have two workpiece surfaces and a workpiece edge therebetween and which are particularly suitable for use in the above method, comprises a housing which has a center axis and in which or at which a holding arrangement and a support arrangement for a workpiece to be processed are received, wherein the holding arrangement has a rubber-elastic sealing sleeve, which is mounted on the housing, with a sealing lip, which encircles the center axis, for contact with the workpiece to be processed, the sealing lip surrounding an opening of the housing to which a sub-atmospheric pressure can be applied so as to hold the workpiece to be processed, while the support arrangement comprises a plurality of pins which are longitudinally displaceable with respect to the housing and can be placed against the workpiece to be processed and which are selectively fixable with respect to the housing by a clamping mechanism; with the feature that associated with each of the pins is a pneumatically loadable piston-cylinder arrangement by way of which the respective pin depending on loading of the piston-cylinder arrangement is selectively movable either in a direction out of the housing and into a support position for the workpiece to be processed or conversely in a direction into the housing and into a parked position.

The pins of the support arrangement can thus be selectively moved forward or back with respect to the housing in correspondence with the respective processing and/or handling requirements and, in fact, independently of the location and position of the workpiece holding head in three dimensions. Consequently, the pins of the support arrangement can either—actively moved out and clamped—suitably support the workpiece, which is retained at the workpiece holding head, against external forces such as, for example, act on the workpiece during processing of the workpiece or—actively moved in and clamped—“securely free the path” so that, for example, undesired workpiece collisions with the pins are reliably avoided and/or rapid movements of the workpiece holding head in three dimensions and on short paths are made possible. By contrast with the prior art discussed above there is advantageously also no need for the influence of gravitational force for use or non-use of the pins, which enables very flexible use of the workpiece holding head with any desired orientation in three dimensions.

In the example of use of spectacle lens production it is thus possible for a spectacle lens to be retained and held, for example, at a processed or finished workpiece surface by the holding arrangement at the workpiece holding head without the pins, which are clamped in retracted position, of the support arrangement coming into contact with this workpiece surface and possibly being able to damage this. On the other hand, a spectacle lens blank, which is to be processed, can be retained at the workpiece holding head and held with support by the clamped pins of the support arrangement, so that, for example, in the case of contact measuring or a processing of the spectacle lens blank it is possible for external forces to act on the spectacle lens blank without the blank in that case being excessively deformed or getting lost from the workpiece holding head.

Further advantages of the provision of a pneumatically loadable piston-cylinder arrangement for each pin are that the individual pins of the support arrangement can be loaded independently of the respective pin movement travel and in simple manner with the same force—pin force equal to pneumatic pressure times effective piston area of the associated piston-cylinder arrangement—before pin clamping takes place. Thus, even in the case of strongly curved prismatically displaced or tilted surface geometries of the workpiece or discontinuous surface geometries of the workpiece—for example in the case of a workpiece with one or more shoulders or steps on the surface to be retained, similar to so-called “bifocal lenses” in the spectacles industry—a retention, which is very homogenous in terms of force as seen over the surface, of the workpiece at the workpiece holding head is possible before the pins are “frozen” by clamping, by contrast with what would be possible in the case of, for example, pins which are resiliently biased only by a helical compression spring and thus can be subject to biasing forces differing in dependence on spring travel, with the risk of inducing stresses in the workpiece when the workpiece is retained. Moreover, it is also conducive to retention of the workpiece at the workpiece holding head homogenously in terms of force if the pins of the support arrangement are distributed on a common pitch circle about the center axis of the housing preferably with uniform angular spacing from one another. This advantageously creates a wide “support base” at the workpiece holding head and counteracts “wobbling”, i.e. deviating movements, on the support arrangement during processing of the retained workpiece.

Not least, an important advantage of pneumatic loading of the piston-cylinder arrangement for the pins of the support arrangement is that the support force before clamping of the pins can be set in simple manner and very flexibly by way of the pneumatic pressure. Finally, the speed of movement of pins can also advantageously be influenced within certain limits by way of the pneumatic pressure. In sum, the workpiece holding head configured in accordance with the invention can be used very flexibly particularly for production of spectacle lenses.

In a preferred, concrete embodiment of the workpiece holding head it can be provided that the pins of the support arrangement in the support position thereof protrude by their ends remote from the housing beyond the opening of the housing for contact with the workpiece to be processed and in their parked position are retracted in the opening of the housing so as to avoid workpiece contact.

In principle, it is possible to design the piston-cylinder arrangement associated with the pins so that the pistons thereof can be loaded in the respective cylinder chamber on two sides with a pressure or a vacuum. However, on the other hand it is preferred particularly with respect to a configuration of the workpiece holding head which is as compact and light as possible if the piston-cylinder arrangements associated with the pins each have a piston loadable with pressure or sub-atmospheric pressure by way of a cylinder chamber.

In that case the configuration can preferably be selected so that the piston of the respective piston-cylinder arrangement when loaded with pressure moves the associated pin into the support position and when loaded with sub-atmospheric pressure moves the associated pin into the parked position. However, an inverse configuration is in principle also possible, with the parked position of the pins being achieved by pressure loading and the support position of the pins being achieved by sub-atmospheric pressure loading of the respectively associated piston-cylinder arrangement; this would, however, be constructionally somewhat more complicated.

Moreover, in a preferred development of the workpiece holding head provision can be made for the piston of the respective piston-cylinder arrangement to be provided on at least one of its end faces with a buffer element for end position damping. This is expedient particularly on that end face of the piston by which the piston in the case of pressure loading would otherwise impact without damping on the housing, so as to make possible rapid piston movements with low output of noise and without the risk of damage to piston and housing.

Fundamentally it is conceivable to load the cylinder chambers of the piston-cylinder arrangements with compressed air or vacuum separately in each instance by way of associated connecting bores. However, on the other hand it is preferred with respect to smallest possible constructional size and lowest possible weight of the workpiece holding head if the cylinder chambers of the piston-cylinder arrangements are loadable with pressure or sub-atmospheric pressure by way of a common annular space in the housing.

For preference each piston, which can be loaded at one side with pressure or sub-atmospheric pressure, of the piston-cylinder arrangements associated with the pins is provided with a groove ring, the static sealing lip of which is secured in a radial groove of the piston and the dynamic sealing lip of which facing the respective cylinder chamber resiliently bears against a piston running surface of the cylinder chamber. By comparison with the possible alternative of an O-ring for piston sealing the provision of a groove ring, i.e. a lip sealing ring at the piston, has at the outset the advantage of lower friction at the associated piston running surface of the cylinder chamber. In general the geometry and bias of the dynamic sealing lip of the groove ring, by which this sealing lip bears against the piston running surface of the cylinder chamber, in conjunction with the material pairing in the contact region very satisfactorily preselects or optimizes with respect thereto that on the one hand in the case of pressure loading of the cylinder chamber the dynamic sealing lip is not pressed too strongly against the piston running surface, with the consequence of high friction forces in the contact region, and on the other hand in the case of loading of the cylinder chamber with sub-atmospheric pressure the dynamic sealing lip does not lift too much off the piston running surface, with the consequence of an only “sluggish” piston movement. To that extent the groove ring in the case of loading of the piston at only one side represents a good “vehicle” for optimizing the in and out travel movements of the respective pin of the support arrangement of the workpiece holding head with respect to easy motion and responsive behavior. Groove rings of that kind are, moreover, readily available in commerce from, for example, the company Freudenberg, Weinheim, Germany.

As far as the holding arrangement of the workpiece holding head is concerned, the rubber-elastic sealing sleeve can basically have any desired annular shape (for example elliptical or polygonal) depending on, in particular, the geometry of the workpiece to be held. However, it is preferred, especially for round workpiece geometries, if the rubber-elastic sealing sleeve of the holding arrangement is of circularly annular shape.

Moreover, the sealing lip of the holding arrangement can be oriented parallely or to extend obliquely radially outwardly/forwardly with respect to the center axis of the housing. However, for holding even smaller workpieces by the holding arrangement of the workpiece holding head it is preferred if the sealing lip of the rubber-elastic sealing sleeve is inclined radially inwardly with respect to the center axis of the housing.

Furthermore, as far as the three-dimensional relationship of holding arrangement and support arrangement is concerned it is preferred particularly for supported holding of round workpieces if the holding arrangement and the support arrangement are mounted in or on the housing in an arrangement concentric with respect to the center axis. Moreover, the pins of the support arrangement can be placed inside or outside the rubber-elastic sealing sleeve in correspondence with the respective holding and supporting arrangements and also in dependence on the size of the workpieces to be held. With regard to highest possible holding forces it is, however, preferred if the pins of the support arrangement are arranged radially within the rubber-elastic sealing sleeve with respect to the center axis of the housing.

In addition, with regard to the clamping mechanism for the support arrangement of the workpiece holding head it is in the first place conducive to a shortest and lightest possible configuration of the workpiece holding head if the sub-atmospheric pressure for the holding arrangement can be preferably applied to the opening of the housing through the clamping mechanism for the pins of the support arrangement.

The clamping mechanism itself can preferably have for each pin of the support arrangement a clamping wedge which can be brought into contact with the associated pin by a common actuating wedge so as to clamp the respective pin relative to the housing. Wedge transmissions of that kind can advantageously generate high holding forces and are particularly low in wear. However, other clamping mechanisms such as known in machine tool construction, for example in accordance with the hydraulic expansion principle, can also be used here even if less preferred particularly with respect to lowest possible weight of the tool holding head.

It is, moreover, conducive to easiest possible motion of the clamping mechanism if the clamping wedges are preferably guided at the housing in clamping direction. Twisting or canting of the clamping wedges in the housing can thus advantageously be resisted.

The clamping mechanism can preferably be pneumatically actuable, especially since the pins of the support arrangement are moved in this way. This is advantageously also conducive to achieving a compact constructional form of the workpiece holding head. Other actuating principles (hydraulic, electrical) are, however, also conceivable.

Thus, in a preferred embodiment of the workpiece holding head there can be associated with the clamping mechanism a piston-cylinder arrangement having a piston which is operatively connected with the actuating wedge and able to be pneumatically loaded on opposite sides so as—by way of the actuating wedge—to either press the clamping wedges against the pins of the support arrangement or to relieve them. Although the use of, for example, a piston-cylinder arrangement pneumatically loadable at one side against spring force is also possible, the afore-mentioned embodiment of the clamping mechanism is preferred particularly with respect to a high degree of actuating reliability.

As far as the support arrangement of the workpiece holding head is concerned the longitudinally displaceable pins of the support arrangement can preferably be cylindrical pins. A round cross-section of the pins is particularly favorable in terms of production even though other cross-sectional shapes for the pins are possible.

Further, for avoidance of undesired deformations of the pins of the support arrangement it is preferred if the pins of the support arrangement are axially guided in the housing over the axial length of the clamping wedges of the clamping mechanism.

Moreover, with respect to production as well as with a view to lowest possible weight and a small need for installation space an embodiment of the workpiece holding head is preferred in which each pin of the support arrangement is formed integrally with a piston of the respectively associated piston-cylinder arrangement. However, a multi-part construction of pin and cylinder is also conceivable here.

With respect to a largest possible support area at the individual pin of the support arrangement and a smallest possible risk of damage to the workpiece to be held it is, moreover, preferred if the ends of the pins remote from the housing are formed to be substantially lens-shaped. By contrast with a spherical cup-shaped pin end this includes a planar pin end with radiusing at the pin edge. However, as an alternative thereto the ends of the pins remote from the housing can also each be provided with a substantially conical tip so as to prevent, in a manner of spikes at car tires or running shoes, lateral slipping of the workpiece, which is held at the workpiece holding head, under external (processing) forces. Any damage arising as a consequence at the held surface of the workpiece is not problematic if this surface is in any case processed in a following step. Moreover, the support arrangement can have between three and nine pins in correspondence with the respective support requirements and installation space restrictions, the support arrangement preferably having six pins.

Finally, in order to be able to mount the workpiece holding head on the most diverse kinematic systems for three-dimensional movement of the workpiece holding head the housing of the workpiece holding head can preferably have—as an interface—a securing section for exchangeable securing to a robot arm of a multi-axis robot or another handling device with corresponding positioning possibilities in three dimensions.

Further features, characteristics and advantages of the method according to the invention and the workpiece holding head according to the invention will be evident to the person ordinarily skilled in the art from the following description of preferred embodiments.

### BRIEF DESCRIPTION OF THE DRAWINGS

The invention is explained in more detail in the following by way of preferred embodiments with reference to the accompanying partly schematic drawings, in which the same or corresponding parts or sections are provided with the same reference numerals and in which:

FIG. 1 shows a perspective view of a combined CNC milling and turning machine for the processing of, in particular, spectacle lenses as optical workpieces (also called “generator”) obliquely from above and front right, on the central workpiece spindle of which a retainer for the workpiece processing is mounted and with which is associated a 6-axis articulated arm robot, which is provided at the end with a workpiece holding head according to a first embodiment of the invention, wherein for simplification of the illustration merely the subassemblies in or at the machine which appear necessary for an understanding of the invention are illustrated;

FIG. 2 shows a perspective view of the machine according to FIG. 1 from obliquely above and front left for illustration of further details of the machine, particularly a workpiece turnover device in front of the workpiece spindle, which in FIG. 1 is concealed by the 6-axis articulated arm robot;

FIG. 3 shows a perspective view of the 6-axis articulated arm robot, which is separated or demounted from the machine according to FIG. 1, with a view onto or into the workpiece holding head according to the first embodiment of the invention mounted on the robot end, for illustration as well of the degrees of freedom of movement of the 6-axis articulated arm robot, which allow free positioning and orientation in three dimensions of the workpiece holding head mounted at the end;

FIG. 4 shows a perspective view of the workpiece holding head according to a first embodiment of the invention, which is separated or demounted from the 6-axis articulated arm robot according to FIGS. 1 to 3 and which comprises a vacuum holding arrangement as well as a support arrangement for the optical workpieces to be processed;

FIG. 5 shows a plan view of the workpiece holding head illustrated in FIG. 4;

FIG. 6 shows a sectional view of the workpiece holding head according to FIG. 4 in correspondence with the section line VI-VI in FIG. 5;

FIG. 7 shows a sectional view of the workpiece holding head according to FIG. 4 in correspondence with the section line VII-VII in FIG. 5;

FIG. 8 shows a sectional view of the workpiece holding head according to FIG. 4 in correspondence with the section line VIII-VIII in FIG. 5;

FIG. 9 shows a sectional view of the workpiece holding head according to FIG. 4 in correspondence with the section line IX-IX in FIG. 5;

FIG. 10 shows a side view of the workpiece holding head illustrated in FIG. 4;

FIG. 11 shows a sectional view of the workpiece holding head according to FIG. 4 in correspondence with the section line XI-XI in FIG. 10;

FIG. 12 shows a perspective view of individual parts of the workpiece holding head according to FIG. 4 for illustration of details of a clamping mechanism for clamping longitudinally displaceable pins of the support arrangement, which in this embodiment are placeable against the workpiece radially within a rubber-elastic sealing sleeve of the vacuum holding arrangement with encircling sealing lip;

FIG. 13 shows a sectional view of the workpiece holding head according to FIG. 4, which corresponds with respect to the section course of FIG. 9, but differs from FIG. 9 in that it is shown how a spectacle lens blank is held at the workpiece holding head by the rubber-elastic sealing sleeve of the holding arrangement through vacuum and in that case experiences axial support by the pins, which are longitudinally displaced to the right by comparison with the illustration in FIG. 9, of the support arrangement, wherein an alternative embodiment of the pin ends is illustrated in a detail circle to the right near the sectional view;

FIG. 14 shows a flow chart of steps for automated workpiece handling in a method, which takes place without use of blocking members, for processing of spectacle lenses by machining in accordance with an embodiment according to the invention, in which the generator shown in FIGS. 1 and 2 can be used with the 6-axis articulated arm robot and the workpiece holding head according to FIGS. 3 to 13, wherein outlined by a dashed line are those handling steps in which one and the same workpiece remains at the workpiece holding head, accordingly with clearer and unambiguous definition of location and position of the workpiece in three dimensions; and

FIG. 15 to FIG. 48 show perspective views and a sectional view (FIG. 36)—in each instance with a view of the workpiece—for illustration of the automated workpiece handling in accordance with the individual handling steps according to FIG. 14 by way of a generator similar to FIGS. 1 and 2, wherein a workpiece holding head according to a second embodiment of the invention is used, which by comparison with the first embodiment has a radially inverted arrangement of the pins for the workpiece support and the sealing sleeve for holding the workpiece.

### DETAILED DESCRIPTION OF THE EMBODIMENTS

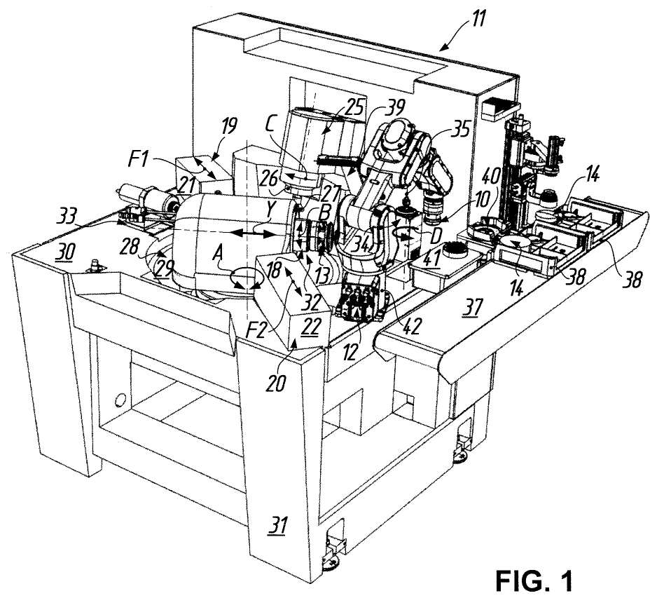

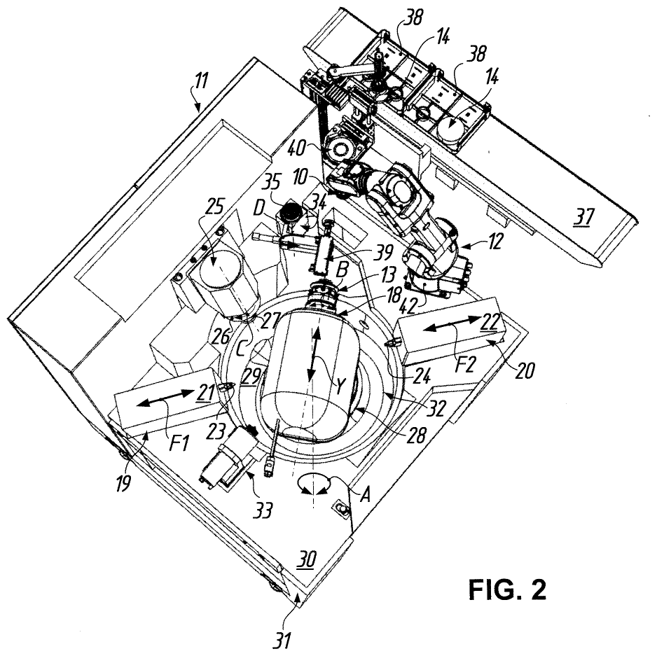

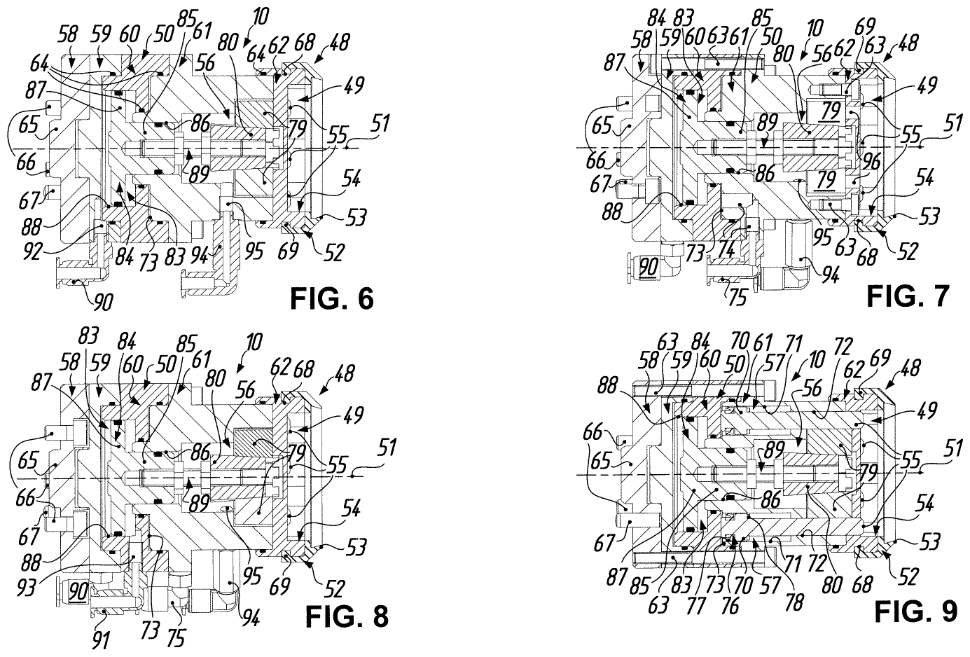

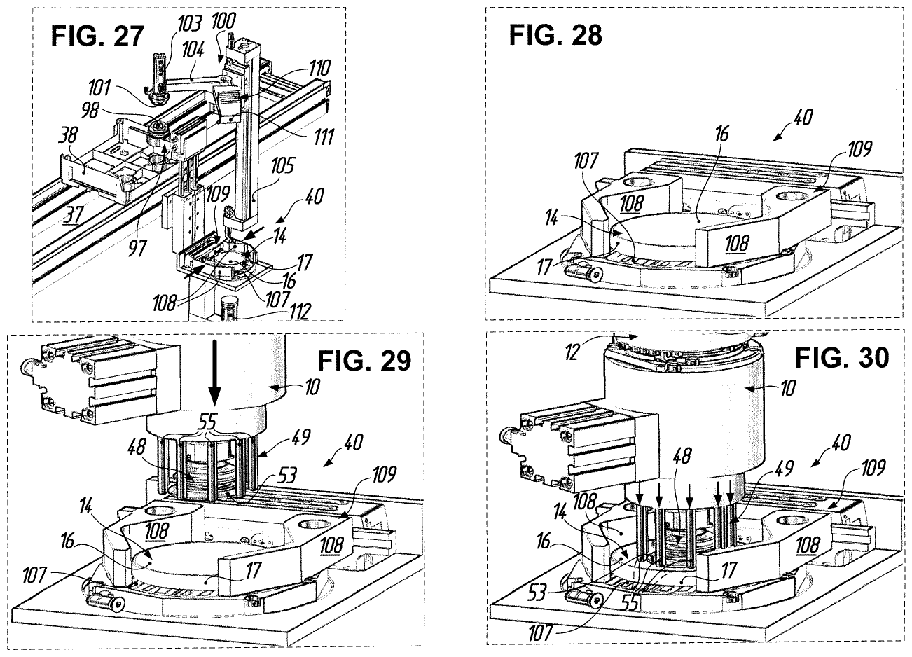

A combined CNC milling/turning machine for the processing of, in particular, spectacle lenses (in short: generator 11) with a 6-axis articulated arm robot 12 as an example for a multi-axis robot is illustrated in FIGS. 1 to 3 by way of example for a technical sphere in which use can be made of a workpiece holding head 10 which is described in detail in the following on the basis of FIGS. 4 to 13 by a first embodiment and with reference to FIGS. 29 to 48 by a second embodiment. Such generators 11 are available from Satisloh AG, Baar, Switzerland, under the commercial designation “VFT-orbit” and are the subject of document EP 2 011 603 A1, to which at this point express reference may be made at the outset with respect to construction and function of the generator 11. In the embodiment illustrated here (FIGS. 1 and 2)—as also later in the more detailed outline of the method sequence (from FIG. 37)—the workpiece during processing thereof in the generator 11 is held with support over an area at a workpiece retainer 13 which is the subject of the earlier German patent application DE 10 2021 005 202.1 of the same applicant, to which express reference may also be made here with respect to construction and function of the workpiece retainer 13.

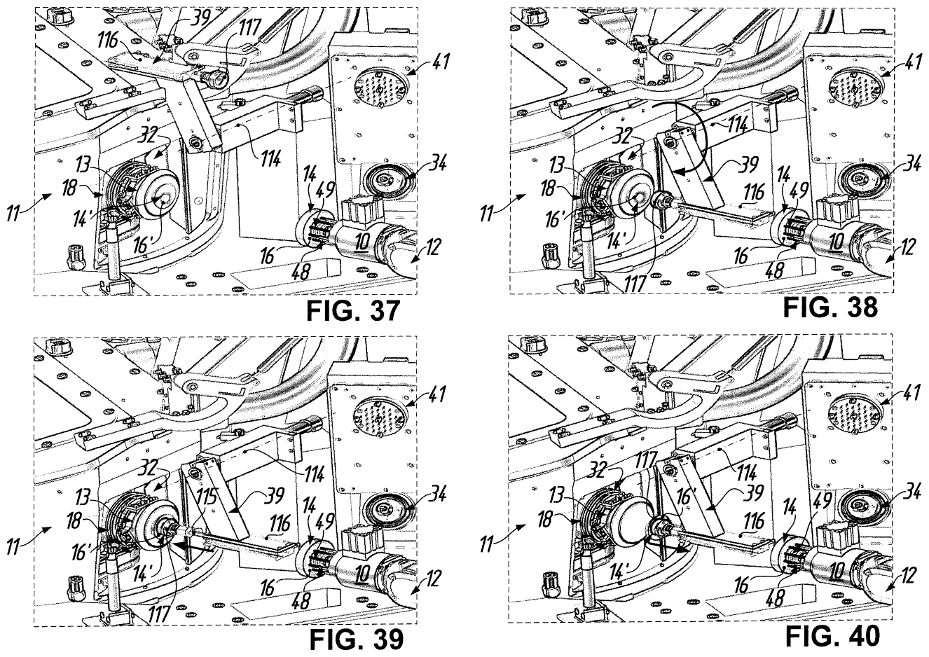

A spectacle lens 14 as an example for an optical workpiece to be processed is shown in FIG. 13. The spectacle lens 14 has two—optically effective at least at the end of the processing—workpiece surfaces, which in the following are termed front side 15 (remote from the eye) and rear side 16 (facing the eye) in correspondence with their position of fitting in a spectacles frame, and a workpiece edge 17 therebetween. In the different processing states, i.e. starting from spectacle lens blank through the partly processed spectacle lens semi-finished product up to the spectacle lens processed to finished state, there is always an areal workpiece which is here denoted throughout by the reference numeral 14 regardless of the respective processing state. As such, the spectacle lens 14 has to be reliably held during processing and handling, particularly insofar as external forces then act on the spectacle lens 14, and at the same time supported against undesired deformations, with respect to which the workpiece holding head 10 described here makes a contribution without holding the spectacle lens 14 at the workpiece edge 17.

In brief, the generator 11 according to FIGS. 1 and 2 comprises a workpiece spindle 18 by which the spectacle lens 14 held in supported manner at the workpiece retainer 13 can be rotationally driven about a workpiece axis B of rotation. In addition, in the illustrated embodiment the generator 11 has three processing units for processing of the spectacle lens 14, which is held at the workpiece spindle 18 by way of the workpiece retainer 13, by machining, namely two turning processing units 19, 20 each with a respective fast-tool servo 21, 22 serving the purpose of producing a linear movement in direction F1 or F2 for a respectively associated turning cutter 23, 24 as turning tool and a milling processing unit 25 with a tool spindle 26 for producing a rotational movement about a tool axis C of rotation for a milling tool 27. Moreover, the generator 12 comprises an adjusting mechanism, which is generally denoted by 28, for producing a relative movement between the workpiece spindle 18 and the respective tool 23, 24, 27 so as to make possible (at least) selectable loading/unloading or processing by machining of the spectacle lens 14. In that regard the adjusting mechanism 28 comprises a linear drive unit as well as a pivot drive unit (neither able to be seen in the figures) which are arranged one above the other, wherein the workpiece spindle 18 is pivotable by the pivot drive unit about a pivot axis A substantially perpendicular to the workpiece axis B of rotation and the workpiece spindle 18 is movable by the linear drive unit along a linear axis Y extending substantially perpendicularly to the pivot axis A and substantially parallely to the workpiece axis B of rotation.

The adjusting mechanism 28 is arranged in the center of an annular trough-like recess 29 which starting from an upper side 30 is formed centrally in a machine frame 31 and bounds a work space 32 of the generator 11. Let into the machine frame 31 around the recess 29, as FIG. 2 in particular shows and starting from the upper side 30 are a plurality of flange surfaces serving for mounting of the processing units 19, 20, 25 in a star-shaped arrangement around the work space 32 and further units or stations still to be described in the following. In addition, according to FIGS. 1 and 2 first of all a measuring station 33 for measuring the spectacle lenses 14, particularly for calibration of the generator 11, is present directly at the recess 29 in the machine frame 31.

Moreover, provided just to the right in FIGS. 1 and 2 of the milling processing unit 25 is a further small milling spindle 34 which is equipped with suitable encapsulation and swarf suction removal (not shown). An end mill 35 can be rotationally driven about a further tool axis D of rotation and under rotational speed control by the milling spindle 34; with regard thereto see also FIGS. 35 and 36, but there in a variant with a substantially horizontal orientation of the tool axis D of rotation particularly for improvement of swarf discharge. This processing unit (milling spindle 34) serves the purpose of forming at the spectacle lens blank 14 by the end mill 35 an encircling groove 36 (cf. FIG. 36), step or an encircling plunge cut in the front side 15 before processing of the rear side 16 of the workpiece 14 then held at the workpiece retainer 13 begins. This procedure for pre-edging or finish-edging in the processing of spectacle lenses 14 is described in detail in earlier German patent application DE 10 2021 004 831.8 of the same applicant, to which at this point express reference may be made with regard to details of the method.

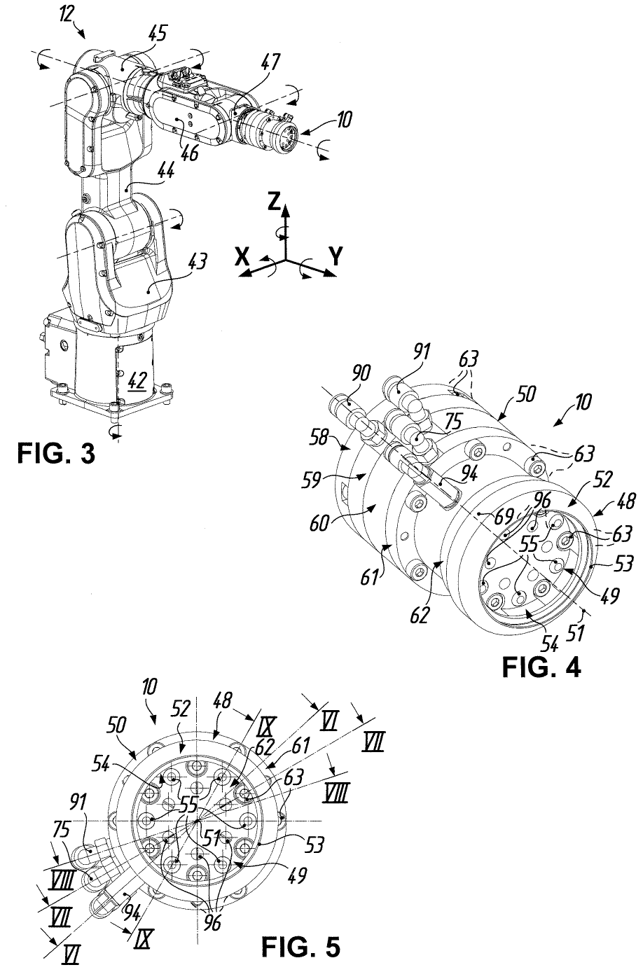

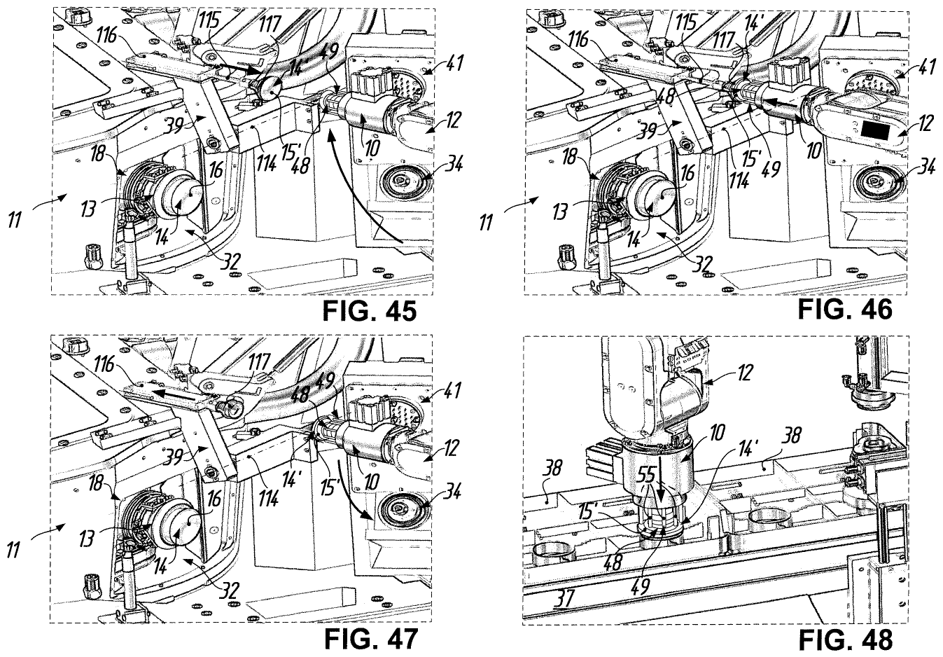

Finally, FIGS. 1 and 2 also show the following subassemblies as further components of the finishing arrangement:
(a) a transport device, which is mounted laterally at the machine frame 31, with a conveyor belt 37 for transport of prescription boxes or job trays 38 in which the spectacle lenses 14 which are to be processed or are processed are transported;
(b) the 6-axis articulated arm robot 12 (see also FIG. 3) which is flange-mounted on the upper side 30 of the machine frame 31 and carries at its free end the workpiece holding head 10 for different tasks still to be described in the following;
(c) a workpiece turnover device 39 which is pivotably held at the machine frame 31 of the generator 11 and which is functionally arranged between the workpiece retainer 13 held at the workpiece spindle 18 of the generator 11 and the workpiece holding head 10 of the 6-axis articulated arm robot 12;
(d) an imaging station 40 (cf. also FIGS. 15 to 32) for fixing and determining the location and position of the spectacle lens blank 14 in three dimensions; and
(e) a measuring station 41—see, in particular, also FIGS. 33 to 35, but there, again, in a different, namely substantially vertical, orientation of the station—for measuring the spectacle lens blank 14, which is held at the workpiece holding head 10, at the front side 15 so as to detect the front side geometry of the spectacle lens blank 14.

The 6-axis articulated arm robot 12 is in a position of transporting spectacle lenses 14, which are to be processed or are processed, by its workpiece holding head 10 between the job trays 38 on the conveyor belt 37, the imaging station 40, the measuring station 41, the milling spindle 34, the workpiece turnover device 39 and the workpiece retainer 13 to the workpiece spindle 18 of the generator 11 and at the respective place to position them in three dimensions in defined manner in correspondence with the processing and/or handling requirements respectively applicable thereto, as is described in more detail in the following. As shown in principle in the embodiment according to FIG. 3 the 6-axis articulated arm robot 12 has for that purpose in a manner known per se starting from a robot base mountable on the machine frame 31 of the generator 11 five robot arms 43, 44, 45, 46, 47 which are arranged one behind the other in a row and pivotable or rotatable relative to one another, as is also indicated in FIG. 3 by rotational arrows and by axes depicted in dashed lines, and which are connected with one another. In that case the workpiece holding head 10 is rotatably mounted on the last, i.e. end, robot arm 47. Appropriate movements of the workpiece holding head 10 can, of course, also be generated by any other handling device with analogous translational and rotational degrees of freedom of movement or positioning possibilities in three dimensions, for example with the assistance of a movement system such as is known in principle from the afore-mentioned document WO 2009/135689 A1 of the present applicant (termed “transport device 18” there), to which at this point express reference may be made for details with respect thereto. Thus, for example, a slide carriage with three linear axes extending perpendicularly to one another can also be provided, which carry the workpiece holding head for the workpiece by way of a base with two mutually perpendicular pivot or rotation axes so that the workpiece holding head is movable in three dimensions by in total five movement axes.

With regard to the further kinematics of the afore-described generator 11, it is also to be noted that the workpiece spindle 18 is movable by the adjusting mechanism 28, which includes a linear drive unit and pivot drive unit, under CNC positional regulation (A axis, Y axis) in a plane extending perpendicularly with respect to the pivot axis A, while the spectacle lens 14 held at the workpiece retainer 13 is rotatable in rotational angle under CNC positional regulation (B axis) about the workpiece axis B of rotation. The spectacle lens 14 can thus be moved from one processing unit or station to the next processing unit or station (A axis) and/or with respect to a processing unit and/or station transversely thereto (A axis, optionally combined with Y axis, particularly for advance movements) and/or with respect to a processing unit or station in a direction towards or away from this (Y axis, particularly for adjusting movements). In that case, on the tool side the milling tool 27 can be rotationally driven by the workpiece spindle 26 of the milling processing unit 25 about the tool axis C of rotation under rotational speed control or the respective turning cutter 23, 24 can be reciprocatingly adjusted by the fast-tool servo 21, 22 along the respective linear axis F1, F2 under CNC positional regulation and in accordance with the surface shape to be generated at the spectacle lens 14, so as to take off cutting chips.

Further details of the workpiece holding head 10 according to the first embodiment can be inferred from FIGS. 4 to 13. In general, the workpiece holding head 10 comprises, for the functions of “holding” and “supporting” a spectacle lens 14 to be processed, a holding arrangement 48 and a support arrangement 49, which are received in or at a housing 50 with a center axis 51 and both of which are still described in detail in the following. The holding arrangement 48 comprises in general a rubber-elastic sealing sleeve 52, which is mounted on the housing 50 and which has a sealing lip 53, which encircles the center axis 51, for contact with the workpiece 14 to be processed. The sealing lip 53 surrounds an opening 54 of the housing 50, to which a sub-atmospheric pressure can be applied in a manner still to be described so as to hold the workpiece 14 to be processed. On the other hand, the support arrangement 49 comprises in general a plurality of pins 55, which are longitudinally displaceable with respect to the housing 50 and can be laid against the workpiece 14 to be processed, the pins being selectively fixable with respect to the housing 50 by a clamping mechanism 56.

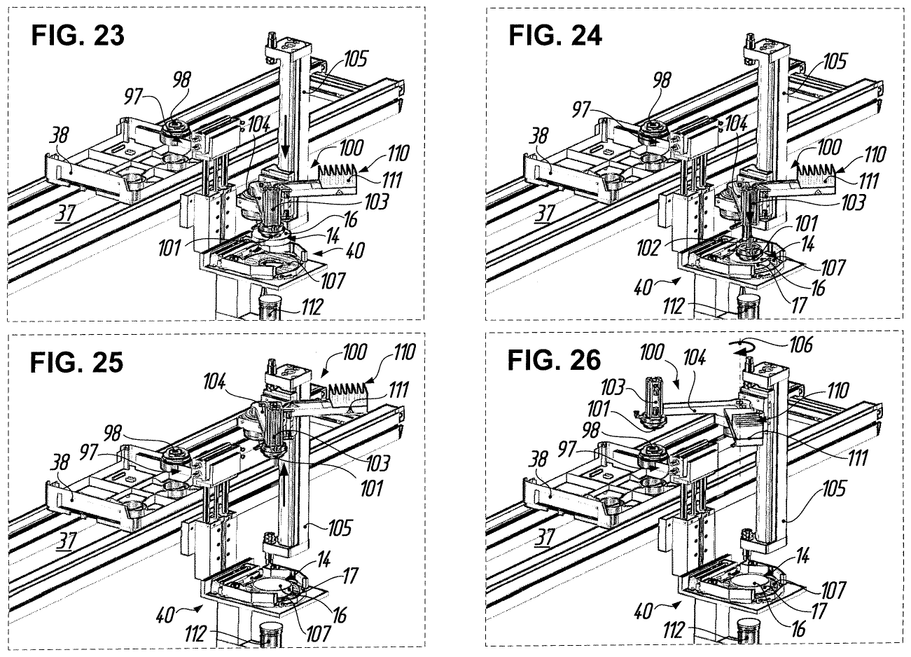

As will also be explained in detail in the following a feature of the workpiece holding head 10 is that associated with each of the pins 55 of the support arrangement 49 is a pneumatically loadable piston-cylinder arrangement 57 by way of which the respective pin 55 is movable in accordance with the loading of the piston-cylinder arrangement 57 selectively either in a direction out of the housing 50 into a support position (shown in FIG. 13) for the workpiece 14 to be processed or conversely in a direction into the housing 50 and into a parked position (illustrated in, in particular, FIGS. 4 and 6 to 9). It is apparent from the mentioned figures that the pins 55 of the support arrangement 49 project by their ends, which are remote from the housing 50, in the support position thereof (FIG. 13) beyond the opening 54 of the housing 50 for contact with the workpiece 14 to be processed, whereas in their parked position (see, for example, FIG. 9) they are retracted in the opening 54 of the housing 50 so as to avoid workpiece contact.

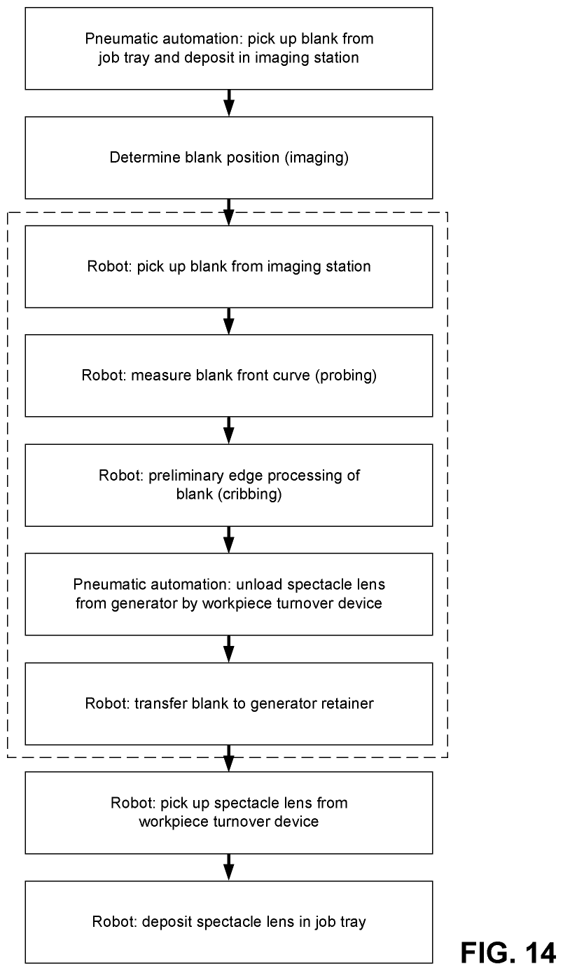

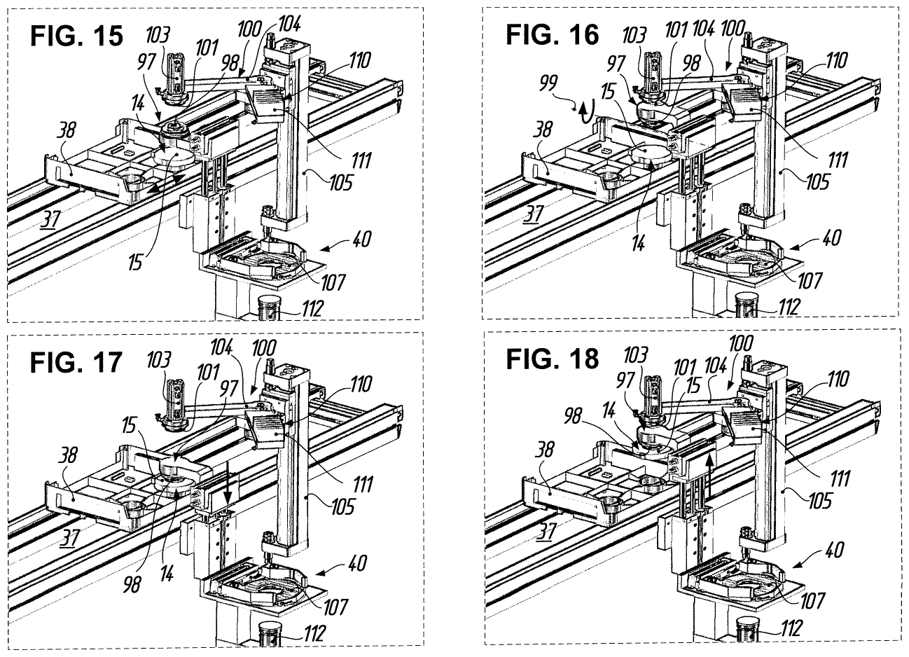

As the sectional views according to FIGS. 6 to 9 and 13, in particular, show, the housing 50 of the workpiece holding head 10 is of multi-part construction from a plurality of metallic housing parts 58 to 62. The individual housing parts 58 to 62 are screw-connected together with the help of housing screws denoted generally by 63, as can be best seen in FIGS. 7, 9 and 13. In that case the housing parts 58 to 62 are centered at one another with respect to the center axis 51 of the housing 50 and sealed relative to one another and relative to the surroundings by O-rings 64 shown in solid black in these figures, as can be seen in, for example, FIG. 6. The housing parts of the workpiece holding head 10 are in detail—seen from left to right in FIGS. 6 to 10 and 13—an adapter plate 58, a cylinder cover 59, a cylinder housing 60, a base 61 and a base plate 62, which shall be described in more detail, particularly functionally, in the following.

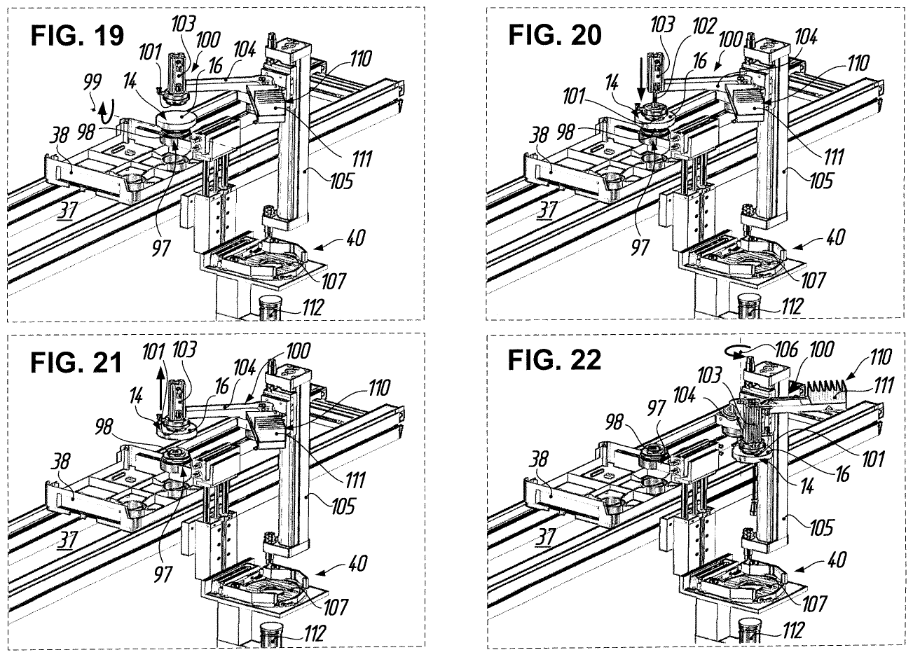

At one end of the workpiece holding head 10 the adapter plate 58 at the outset forms a securing section of the housing 50, by way of which the workpiece holding head 10 in the illustrated embodiment is exchangeably secured to the robot arm 47 of the 6-axis articulated arm robot 12, so that the workpiece holding head 10 can be moved in three dimensions by the 6-axis articulated arm robot 12. In that regard a centering shoulder 65 of the adapter plate 58 centers the housing 50 at the robot arm 47 of the 6-axis articulated arm robot 12. A plurality of fastening screws 66 (cf. FIG. 8) serves for detachable fastening of the adapter plate 58 to the robot arm 47, while a dowel pin 67 (see FIG. 9) in that case ensures correct angular orientation of the housing 50 about the center axis 51.

At the other end of the workpiece holding head 10 the housing 50 terminates with the base plate 62, which bounds the vacuum-loadable opening 54 of the housing 50. At the outer circumference the base plate 62 is provided with a radial groove 68 in which the rubber-elastic sealing sleeve 52, which is of circularly annular configuration, of the holding arrangement 48 is secured by a securing section 69. As can be inferred from, in particular, the sectional views according to FIGS. 6 to 9 and 13 the sealing lip 53 of the rubber-elastic sealing sleeve 52 is in that case inclined radially inwardly with respect to the center axis 51 of the housing 50.

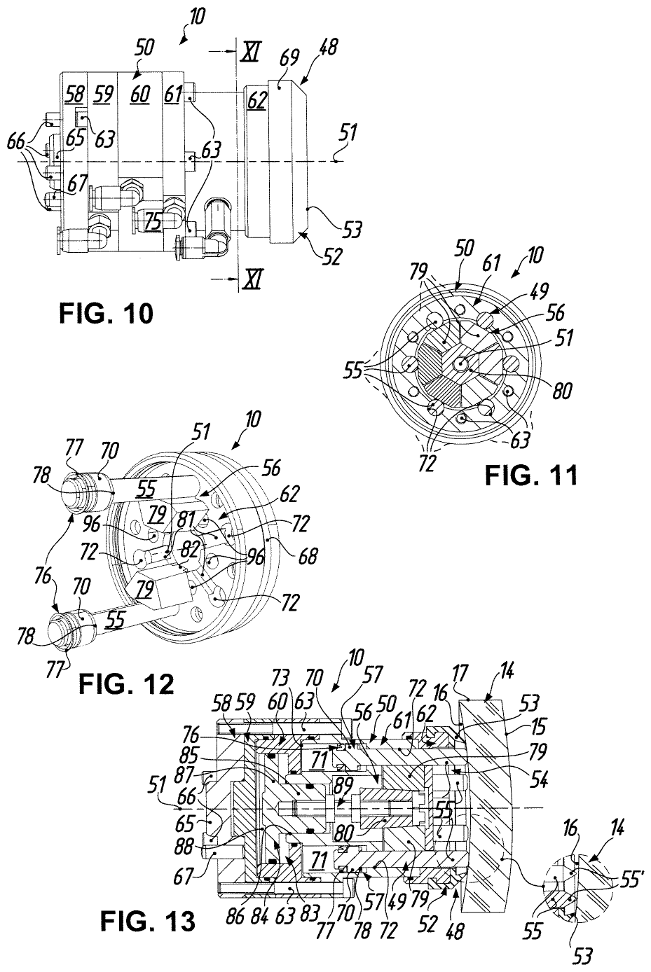

It can be inferred particularly easily from the perspective view according to FIG. 4 and the plan view of the base plate 62 according to FIG. 5 that the holding arrangement 48 and the support arrangement 49 of the workpiece holding head 10 are received in or at the housing 50 in an arrangement concentric with respect to the center axis 51. In the first embodiment of the workpiece holding head 10 shown here the pins 55 of the support arrangement 49 are then arranged radially within the rubber-elastic sealing sleeve 52 with respect to the center axis 51 of the housing 50. These figures also show that the six pins 55 of the support arrangement 49 in the illustrated embodiment are distributed on a common pitch circle about the center axis 51 of the housing 50 with uniform angular spacing from one another. Moreover, it can be readily seen here that the longitudinally displaceable pins 55 of the support arrangement 49 are cylindrical pins (cf. FIG. 5) which according to, in particular, FIG. 4 are formed at the ends thereof remote from the housing 50 to be substantially lens-shaped with a central flat region and a radiusing at the edge. In an alternative embodiment with respect thereto the ends of the pins 55 remote from the housing 50 can, however, also be provided with a substantially conical tip 55′ as is illustrated in the detail circle on the right in FIG. 13, which prevents slipping—laterally with respect to the center axis 51—of the spectacle lens 14, which is held at the workpiece holding head 10, under transverse forces acting, for example, tangentially to the spectacle lens 14 during the processing.

The central core of the housing 50 is the base 61 which in a very compact configuration receives essential components of the support arrangement 49 and of the clamping mechanism 56 therefor. In the first instance it is to be stated in this connection that in the illustrated embodiment each pin 55 of the support arrangement 49 is formed integrally with a piston 70 of the respectively associated piston-cylinder arrangement 57, as FIGS. 9, 12 and 13 show. In that regard the base 61 forms, in correspondence with the pin number, cylinder chambers 71 for reception of the pistons 70. On the side of the cylinder chambers 71 on the right in FIGS. 9 and 13 the pins 55 extend through bores 72 in the base 61 and the base plate 62 so as to end by their substantially lens-shaped—or pointed—ends in the opening 54 of the base plate 62.

In the illustrated embodiment the pistons 70 of the piston-cylinder arrangements 57 for the pins are not loadable on both sides with pressure or sub-atmospheric pressure—which would also be possible—but are each loadable on one side with pressure or sub-atmospheric pressure by way of the associated cylinder chamber 71. For that purpose the cylinder chambers 71 of the piston-cylinder arrangements 57 on the side on the base 61 which is at the left in FIGS. 6 to 9 and 13 communicate with a common annular space 73 in the housing 50, which is formed between the base 61 and the cylinder housing 60. This annular space 73 is in turn pneumatically connected by way of connecting bores 74, which are shown in FIG. 7, in the base 61 with a pneumatic connection 75, which is mounted externally on the base 61, for actuation of the support arrangement 49. It will be evident to the person ordinarily skilled in the art that the piston 70 of the respective piston-cylinder arrangement 57—upon pressure loading of the cylinder chambers 71, which here takes place by way of the pneumatic connection 75, the connecting bores 74 in the base 61 and the common annular space 73 (cf. FIG. 7)—moves or pushes the associated pin 55 into the support position (cf. FIG. 13) and—upon loading with a sub-atmospheric pressure, which here proceeds in the same way—moves or draws the associated pin 55 into the parked position (cf. FIG. 9).

For that purpose each piston 70, which is loadable at one side by pressure or sub-atmospheric pressure, of the piston-cylinder arrangements 57 associated with the pins 55 is provided with a groove ring 76 as shown in FIGS. 9, 12 and 13. The static sealing lip of the respective groove ring 76 is secured in a radial groove of the piston 70 (see FIGS. 9 and 13), whereas the dynamic sealing lip 77 thereof facing the respective pneumatically loaded cylinder space 71 resiliently bears against a piston running surface of the cylinder chamber 71. Finally, it can also be seen in FIGS. 9, 12 and 13 that the piston 70 of the respective piston-cylinder arrangement 57 is provided on its end face facing the free end of the appropriate pin 55 with a buffer element 78 for end position damping, which prevents the piston 70 when the cylinder chamber 71 is loaded with pressure from hitting the base of the bore in the base 61 without damping.

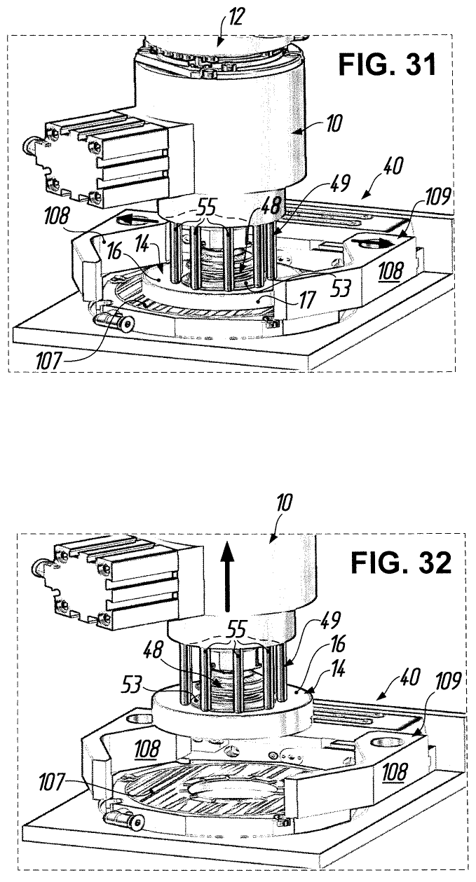

As far as further specifics of the clamping mechanism 56 for the pins 55 of the support arrangement 49 are concerned it is firstly to be said that the clamping mechanism 56 in the present embodiment operates with a wedge principle. More precisely, the clamping mechanism 56 has for each pin 55 of the support arrangement 49 a clamping wedge 79 as can be best seen in the cross-section according to FIG. 11. The respective clamping wedge 79 can be brought into contact with the associated pin 55 by an actuating wedge 80 which is common to all clamping wedges 79 and is six-sided as considered in cross-section, so as to clamp the respective pin 55 with respect to the housing 50. In that regard, the pin 55 loaded by the associated clamping wedge 79 is supported at the circumference of the bores 72 in the base 61 and the base plate 62, which for engagement of the respective clamping wedge 79 with the associated pin 55 are drilled-out radially in the direction of the actuating wedge 80, as FIG. 11 shows.

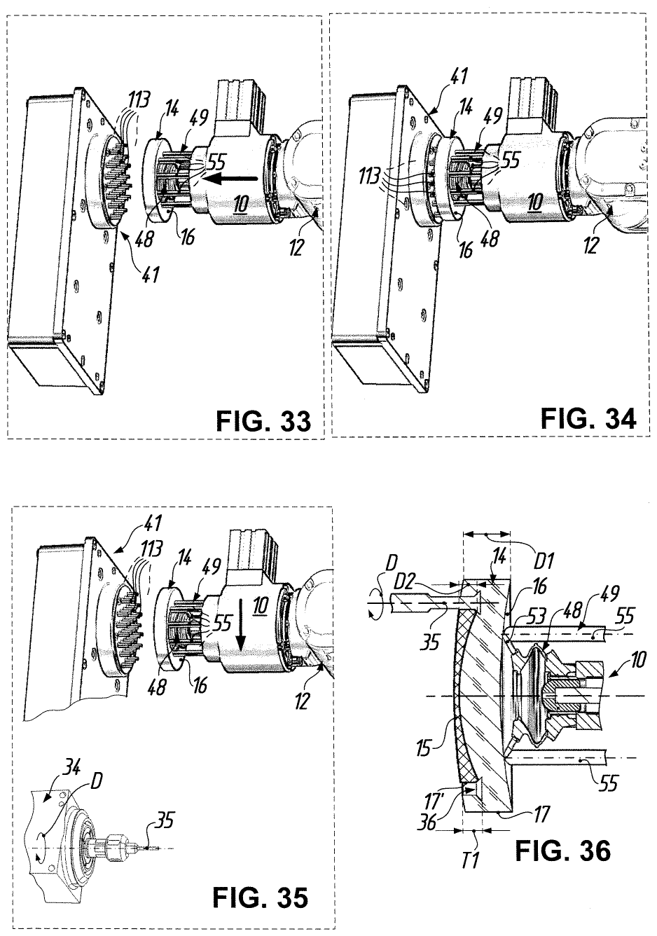

In this connection, the perspective view according to FIG. 12, which for better illustration of the clamping mechanism 56 shows only two pin/wedge pairings 55/79 at the base plate 62 of the housing 50, illustrates that the clamping wedges 79 are guided at the housing 50 in clamping direction. More precisely, formed for that purpose in the base plate 62 are guide grooves 81, which extend radially with respect to the center axis 51 of the housing 50, for slidable reception of guide projections 82 of complementary form at the clamping wedges 79. The pins 55 of the support arrangement 49 are axially guided in the housing 50 in axial direction, as seen along the center axis 51, over the axial length of the clamping wedges 79 of the clamping mechanism 56, namely in the lateral, i.e. radially inwardly open, bores 72 of the base 61 and the base plate 62.

Moreover, the clamping mechanism 56 can also be pneumatically actuated. For that purpose a piston-cylinder arrangement 83, the piston 84 of which is in operative connection with the actuating wedge 80, is associated with the clamping mechanism 56. The piston 84 of the clamping mechanism 56 can be pneumatically loaded on opposite sides so as to—by way of the actuating wedge 80—urge the clamping wedges 79 of the clamping mechanism 56 either against the pins 55 of the support arrangement 49 or to relieve them. The piston 84 according to FIGS. 6 to 9 and 13 is for that purpose guided by a piston shaft 85 in a central bore 86 of the base 61, while a piston head 87, which is integrally connected with the piston shaft 85, of the piston 84 runs with suitable sealing at the outer circumference in a cylinder chamber 88 which is formed in the cylinder housing 60 and on which the side remote from the clamping mechanism 56 is bounded by the cylinder cover 59. A mechanical connecting arrangement 89, which according to FIGS. 6 to 9 and 13 comprises a threaded rod screwed into central threaded bores in the actuating wedge 80 and in the piston 84 and secured thereat in longitudinally settable manner by a respective lock nut, ensures a tension-resistant and pressure-resistant connection between the actuating wedge 80 and the piston 84 of the clamping mechanism 56.

Two pneumatic connections 90, 91 are provided at the housing 50 for pneumatic loading of the piston-cylinder arrangement 83 of the clamping mechanism 56. According to FIG. 6 the first pneumatic connection 90 is mounted on the cylinder cover 59 and is pneumatically connected with the cylinder chamber 88 in the cylinder housing 60 by way of a connecting bore 92 (cf. FIG. 6) in the cylinder cover 59. It is apparent that for clamping of the pins 55 the clamping mechanism 56 can thus be actuated by loading of the pneumatic connection 90 with compressed air, wherein the actuating wedge 80—pushed by the piston 84, which is loaded in pressure, by way of the connecting arrangement 89—moves to the right in FIGS. 6 to 9 and 13 and pushes the clamping wedges 79 radially outwardly due to the wedging action.

According to FIG. 8 the second pneumatic connection 91 is mounted on the cylinder housing 60 and is pneumatically connected by way of a connecting bore 93 (cf. FIG. 8) in the cylinder housing 60 with the cylinder chamber 88 thereof. It is further apparent that the clamping mechanism 56 can thus be released by loading of the pneumatic connection 91 with compressed air for freeing the pins 55, wherein the actuating wedge 80, which is drawn by the pressure-loaded piston 84 by way of the connecting arrangement 89, moves to the left in FIGS. 6 to 9 and 13 and frees the clamping wedges 79 in radial direction.

In addition, there can be seen in FIGS. 4 to 8 a further pneumatic connection 94 at the housing 50, which is mounted at the base 61 and communicates by way of a connecting bore 95 (cf. in particular FIG. 6) in the base 61 with the interior of the base 61. The vacuum for the holding arrangement 48 can be applied to this pneumatic connection 94. In that regard, the sub-atmospheric pressure in the base 61 passes through the clamping mechanism 56 for the pins 55 of the support arrangement 49 to the opening 54 of the housing 50 and, in fact, by way of six axial bores 96 in the base plate 62, these being visible in FIGS. 4, 5, 7 and 12.

To that extent it will be apparent to the person ordinarily skilled in the art how a spectacle lens 14 to be processed can be held by vacuum by the afore-described workpiece holding head 10 with the assistance of the holding arrangement 48 and in that case be selectively subject to support by the support arrangement 49, which in that regard can be selectively fixed by the clamping mechanism 56, as shown overall in FIG. 13.

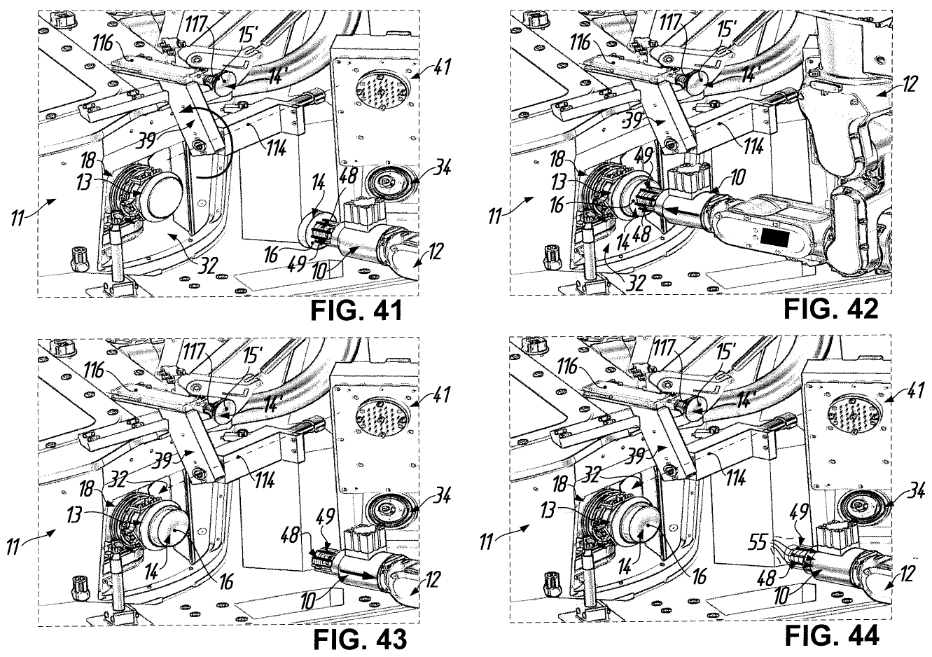

In addition, an embodiment of a method for processing of spectacle lenses 14 by machining shall be described in the following by way of FIGS. 14 to 48, in which starting from a blank a semi-finished product with predetermined surface geometries at a front side 15 and at a rear side 16 remote therefrom and with an edge 17 between the front side 15 and the rear side 16 is formed. In that case use is made of a workpiece holding head 10 according to a second embodiment, which has the above afore-mentioned functionalities, i.e. (1st) holding arrangement 48 with sealing lip 53 and vacuum, (2nd) support arrangement 49 with pins 55 which are selectively movable out and in and which can be fixed in their respective position by (3rd) a clamping mechanism, but this in a different physical arrangement, namely with transposed radial position of holding arrangement 48 (now radially inwardly) and support arrangement 49 (now radially outwardly). However, description of further constructional details of the workpiece holding head 10 according to the second embodiment shall be omitted at this point, because this does not appear necessary for an understanding of the method sequence.

The machine environment is also slightly modified relative to the illustration in FIGS. 1 and 2—inter alia the measuring station 41 and the milling spindle 34 are placed one above the other in vertical arrangement, especially so as to realize therebetween particularly short movement paths for the workpiece holding head 10—which again, however, is not relevant for an understanding of the method sequence and therefore shall not be explained in more detail.

In general, the method comprises the following main steps taking place in the indicated sequence:
i) providing the blank which can have the already predetermined surface geometry at the front side 15 and is to be processed at least at the rear side 16, for example from one of the job trays 38 on the conveyor belt 37;
ii) fixing and determining location and position of the blank in three dimensions, in the imaging station 40 in the case of the embodiment;
iii) block-free retention of the blank at the rear side 16, with consideration of the location and position data determined in step ii), by the workpiece holding head 10, which is arranged to be positionable with three-dimensional definition, for supported holding of the workpiece 14, which can be carried out, for example, with the assistance of the 6-axis articulated arm robot 12 according to FIG. 3 or another handling kinematic system with corresponding degrees of freedom of movement, as shown on the right in FIG. 3;
iv) measuring the blank, which is held by the workpiece holding head 10, at the front side 15 for detecting the front side geometry, in the measuring station 41 in the case of the embodiment;
v) direct transfer of the workpiece 14 from the workpiece holding head 10 to the workpiece retainer 13, which is arranged to be positionable with position and angle definition, for example in the generator 11 according to FIGS. 1 and 2, for block-free retention of the workpiece 14 at the front side 15 with consideration of the front side geometry data detected in step iv) and for supported holding of the workpiece 14; and
vi) processing the workpiece 14 at the rear side 16 by at least one tool—for example, the milling tool 27 and/or the turning cutters 23, 24 of the generator 11 according to FIGS. 1 and 2—for formation the semi-finished product with the predetermined surface geometry at the rear side 16;

with the particular feature that the workpiece 14 is held at the workpiece holding head 10 without interruption between the steps iii) and v) so that location and position of the workpiece 14 in three dimensions are always clearly and unambiguously defined.

As a further particular feature an optional step is inserted in the sequence according to FIGS. 14 to 48, i.e. in FIG. 14 the point designated by “Robot: preliminary edge processing of blank (cribbing)”: In terms of time, in particular between the step iv) of measuring the blank 14 and the step v) of direct transfer of the workpiece 14 from the workpiece holding head 10 to the workpiece retainer 13 a processing step vii) is carried out in which the blank 14 held at the workpiece holding head 10 is processed in such a way that there is left at the workpiece 14 a circumferential area which defines a contoured edge 17′ of the semi-finished product to be formed. In this processing step vii), which is illustrated in FIGS. 35 and 36, the blank 14 is processed at the front side by a tool—for example the end mill 35 according to FIGS. 1 and 2—so as to produce an encircling groove 36 (or step, not shown) with a depth T1, which is greater than or equal to an edge thickness D2 of the semi-finished product to be formed and smaller than a blank thickness D1, or an encircling plunge cut (also not illustrated), which has at least in part a depth equal to the blank thickness. Further details as well as the meaning and purpose of this procedure are described in detail in earlier German patent application DE 10 2021 004 831.8 of the same applicant, to which express reference may again be made at this point.

The actual sequence according to FIGS. 15 to 48 can now be summarized more easily in the manner of bullet points as follows, wherein arrows in the figures illustrate the respective movements:
FIG. 15: The blank 14 stored in the job tray 38 with the front side 15 upward is moved by the conveyor belt 37 into a removal position below a transfer device 97 which is arranged at the conveyor belt 37 and which is equipped with a first sucker 98 for picking up the bank 14.
FIG. 16: The transfer device 97 is rotated about a pivot axis 99 so that the first sucker 98 is arranged opposite the blank 14.
FIG. 17: The transfer device 97 is moved in the direction of the job tray 38 into a lens pick-up position in which the first sucker 98 bears against the front side 15 of the blank 14. The blank 14 is held at the first sucker 98 through application of a vacuum.
FIG. 18: The blank 14 held at the first sucker 98 is moved upwardly by the transfer device 97 into an upper end position of the transfer device 97.
FIG. 19: The transfer device 97 is further rotated through 180 degrees about its pivot axis 99 so that the blank 14 rests from above on the transfer device 97. The rear side 16 of the blank 14 now points upwardly. In this position, transfer of the blank 14 to a further conveying device 100 takes place, at which the blank 14 is held by its rear side 16 by a second sucker 101.
FIG. 20: The second sucker 101 of the further conveying device 100 is held at the end of a piston rod 102 of a transfer cylinder 103, which in turn is arranged at the end of a pivot arm 104 movable by a stroke mechanism 105 transversely to the conveyor belt 37, thus in the direction of the imaging station 40. The second sucker 101 is moved by the transfer cylinder 103 in the direction of the blank 14 until the second sucker 101 rests on the rear side 16 of the blank 14. In this position, initially the second sucker 101 of the further conveying device 100 is acted on by a sub-atmospheric pressure and subsequently the first sucker 98 of the transfer device 97 is ventilated.
FIG. 21: The blank 14 held at the rear side 16 by the second sucker 101 is lifted off the transfer device 97 by the transfer cylinder 103.
FIG. 22: The blank 14 is pivoted by the pivot arm 104 about a pivot axis 106 of the further conveying device 100 over the imaging station 40.
FIG. 23: the stroke mechanism 105 is moved into its lower end position.
FIG. 24: The blank 14 is deposited with the front side 15 downward on a deposit surface 107 of the imaging station 40 by the transfer cylinder 103 and the second sucker 101 is ventilated.
FIG. 25: The stroke mechanism 105 is moved into its upper end position.
FIG. 26: The transfer cylinder 103 is pivoted about the pivot axis 106 into its parked position by way of the transfer device 97.
FIG. 27: Two linearly movable grip arms 108 of a centering gripper 109 of the imaging station 40 are moved towards one another so as to geometrically center the blank 14 at its workpiece edge 17 in the imaging station 40 and thus establish the location of the blank 14 in three dimensions, in correspondence with the first part of the above method step ii).
FIG. 28: The blank 14 is held by the centering gripper 109 on the imaging station 40. In this position the blank 14 is checked by an optical measuring system 110, which is known per se, with a transmitter 111 and receiver 112—shown in principle in FIGS. 15 to 27, for example a video system—with respect to markings applied during production of the blank 14. This serves the purpose of determining the position of the blank 14, i.e. the orientation thereof, in three dimensions, in correspondence with the second part of the above method step ii).
FIG. 29: The workpiece holding head 10 held in the embodiment at the 6-axis articulated arm robot 12 is positioned relative to the blank 14 with definition in three dimensions.
FIG. 30: The holding arrangement 48 with the sealing lip 53 of the workpiece holding head 10 and then the support arrangement 49 with the pins 55, which can be moved out, of the workpiece holding head 10 are brought into contact with the blank 14, more precisely the rear side 16 thereof. The pins 55 of the support arrangement 49 are secured by the clamping mechanism of the workpiece holding head 10 against displacement. A sub-atmospheric pressure is then applied to the holding arrangement 48 of the workpiece holding head 10 so as to firmly hold the blank 14 by the holding arrangement 48 at the workpiece holding head 10. Location and position of the blank 14 are now fixed in three dimensions.
FIG. 31: The grip arms 108 of the centering gripper 109 of the imaging station 40 are moved apart so as to release the blank 14 from the imaging station 40.
FIG. 32: The workpiece holding head 10 with the blank 14 held thereat with support is, in the embodiment, lifted upwardly from the support surface 107 out of the imaging station 40 by the 6-axis articulated arm robot 12 and transported in the direction of the measuring station 41.
FIG. 33: The blank 14 is moved towards the measuring scanner 113 of the measuring station 41 for scanning its front side 15.
FIG. 34: The blank 14 has reached its end position with respect to the measuring scanner 113 of the measuring station 41. The blank 14 held by the workpiece holding head 10 is now subject to contact scanning so as to detect the front side geometry in the step iv) of measuring the blank 14. Depending on the respective measuring requirements the blank 14 can in correspondence with FIGS. 33 and 34 also be moved several times as well as optionally offset and/or tilted relative to the measuring scanner 113 of the measuring station 41 so as to fully detect the front side geometry of the blank 14.
FIG. 35: After the front side geometry data has been detected by the measuring scanner 113 of the measuring station 41 the blank 14 can, in the embodiment, be transported by the 6-axis articulated arm robot 12 in the direction of the milling spindle 34, which here is stationary.
FIG. 36: The blank 14 held at the workpiece holding head 10 with support is, in the embodiment, guided by the 6-axis articulated arm robot 12 with respect to the end mill 35—which in that case is driven by the positionally fixed milling spindle 34 for rotation about the axis D of rotation—in such a way that an encircling groove 36 or step or an encircling plunge cut is milled into the front side 15 of the blank 14 as already explained above. A fresh measuring step can follow this optional processing step, for example with contact scanning in correspondence with FIGS. 33 and 34, wherein the workpiece 14 is again measured at the front side 15 so as to check location and position of the workpiece 14 at the workpiece holding head 10.
FIG. 37: For the next processing step the workpiece 16 has to be transferred to the workpiece retainer 13 of the generator 11. In the case of continuous spectacle lens production initially the semi-finished product 14′, which is held by this workpiece retainer 13 and processed at least at the rear side 16′, of the preceding production order has to be unloaded.
FIG. 38: The workpiece turnover device 39 arranged outside the work space 32 of the generator 11 is pivoted about an axis 114 of rotation.
FIG. 39: A third sucker 117 arranged at a piston rod 115 of a thrust cylinder 116 is moved in the direction of the workpiece retainer 13 into the work space 32 of the generator 11 until the third sucker 117 bears against the rear side 16′ of the processed semi-finished product 14′. Subsequently, the semi-finished product 14′ is fixed by application of a vacuum to the third sucker 117 and released from the workpiece retainer 13 by ventilating the workpiece retainer 13.
FIG. 40: The third sucker 117 mounted on the piston rod 115 of the thrust cylinder 116 together with the processed semi-finished product 14′ held thereat is moved out of the work space 32 of the generator 11.
FIG. 41: The workpiece turnover device 39 is pivoted about the axis 114 of rotation back into its parked position, whereby the workpiece retainer 13 is freed.
FIG. 42: The new workpiece 14 held at the workpiece holding head 10 with support is, in the embodiment, positioned by the 6-axis articulated arm robot 12 with its front side 15 on the workpiece retainer 13, whereupon a holding vacuum is applied to the workpiece retainer 13 of the generator 11 and the holding arrangement 48 of the workpiece holding head 10 is ventilated for defined workpiece transfer. Processing of the rear side 16 of the workpiece 14 in the generator 11 can now begin.
FIG. 43: The now unloaded workpiece holding head 10 is, in the embodiment, drawn back by the 6-axis articulated arm robot 12 from the workpiece retainer 13 of the generator 11.
FIG. 44: The pins 55 of the support arrangement 49 of the workpiece holding head 10 are actively retracted into the parked position so that only the holding arrangement 48 projects from the unloaded workpiece holding head 10.
FIG. 45: The unloaded workpiece holding head 10 is, in the embodiment, positioned by the 6-axis articulated arm robot 12 in front of the workpiece turnover device 39 and the semi-finished product 14′ processed to finished state is moved with its front side 15′ foremost by way the piston rod 115 of the thrust cylinder 116 in the direction of the unloaded workpiece holding head 10.
FIG. 46: In the embodiment the workpiece holding head 10 is moved with its flexible holding arrangement 48 foremost by the 6-axis articulated arm robot 12 for the take-over towards the front side 15′ of the semi-finished product 14′. Since the pins 55 of the support arrangement 49 of the workpiece holding head 10 are in that case actively retracted they cannot collide with the front side 15′ of the semi-finished product 14′. A holding vacuum is now applied to the holding arrangement 48 of the workpiece holding head 10, after which the third sucker 117 at the workpiece turnover device 39 of the generator 11 is ventilated, whereby the semi-finished product 14′ is transferred to the workpiece holding head 10.
FIG. 47: The piston rod 115 of the thrust cylinder 116 is retracted at the workpiece turnover device 39.
FIG. 48: In the embodiment the semi-finished product 14′ held at the holding arrangement 48 of the workpiece holding head 10 without support is placed by the 6-axis articulated arm robot 12 in the job tray 38 on the conveyor belt 37 and the holding arrangement 48 of the workpiece holding head 10 is ventilated for deposit of the workpiece.

Although it was described above with reference to, in particular, FIGS. 37 to 48 that the workpiece holding head 10 guided by the multi-axis robot 12 in the shown embodiment also (conjunctively) serves the purpose of unloading the semi-finished product 14′, which is processed at the rear side 16′, from the generator 11 use can also be made for workpiece unloading from the generator 11 of a different, i.e. further, handling device (not shown). This further handling device can also, in principle, finally deposit the semi-finished product 14′—without prior turning of the semi-finished product 14′—in such a way in the job tray 38 on the conveyor belt 37 that the front side 15′ of the semi-finished product 14′ does not—as shown in FIG. 48—face upwardly, but rather the rear side 16′ thereof, i.e. the semi-finished product 14′, is deposited on its front side 15′ in the job tray 38. The front-side or rear-side deposit of the semi-finished product 14′ in the job tray 38 ultimately depends on how the following steps are arranged.

A workpiece holding head has a housing in or at which a holding arrangement and a support arrangement for an optical workpiece are received. The holding arrangement has a rubber-elastic sealing sleeve, which is mounted on the housing, with an encircling sealing lip for contact with the workpiece, which surrounds a vacuum-loadable opening of the housing. The support arrangement comprises a plurality of longitudinally displaceable pins which can be placed against the workpiece and which are fixable with respect to the housing by a clamping mechanism. Associated with each of the pins is a pneumatically loadable piston-cylinder arrangement by way of which the pin depending on pneumatic loading is movable with respect to the housing outwardly into a support position for the workpiece or conversely inwardly into a parked position avoiding workpiece contact. In addition, a method for processing of spectacle lenses by machining without use of a blocking member is disclosed, in which, for example, such a workpiece holding head ensures always unambiguous definition of location and position of the workpiece in three dimensions.

### REFERENCE NUMERAL LIST

10 workpiece holding head
11 generator (combined CNC milling/turning machine)
12 6-axis articulated arm robot/multi-axis robot
13 workpiece retainer
14, 14′ spectacle lens/workpiece
15, 15′ front side
16, 16′ rear side
17, 17′ workpiece edge
18 workpiece spindle
19 turning processing unit
20 turning processing unit
21 fast-tool servo
22 fast-tool servo
23 turning cutter
24 turning cutter
25 milling processing unit
26 workpiece spindle
27 milling tool
28 adjusting mechanism
29 recess
30 upper side
31 machine frame
32 work space
33 measuring station
34 milling spindle
35 end mill
36 groove
37 conveyor belt
38 job tray
39 workpiece turnover device
40 imaging station
41 measuring station
42 robot base
43 robot arm
44 robot arm
45 robot arm
46 robot arm
47 robot arm
48 holding arrangement
49 support arrangement
50 housing
51 center axis
52 sealing sleeve
53 sealing lip
54 opening
55 pin
55′ tip
56 clamping mechanism
57 piston-cylinder arrangement
58 adapter plate, housing part
59 cylinder cover, housing part
60 cylinder housing, housing part
61 base, housing part
62 base plate, housing part
63 housing screw
64 O-ring
65 centering shoulder
66 securing screw
67 dowel pin
68 radial groove
69 securing section
70 piston
71 cylinder chamber
72 bore
73 annular space
74 connecting bore
75 pneumatic connection
76 groove ring
77 dynamic sealing lip
78 buffer element
79 clamping wedge
80 actuating wedge
81 guide groove
82 guide projection
83 piston-cylinder arrangement
84 piston
85 piston shaft
86 central bore
87 piston head
88 cylinder chamber
89 connecting arrangement
90 pneumatic connection
91 pneumatic connection
92 connecting bore
93 connecting bore
94 pneumatic connection
95 connecting bore
96 axial bore
97 transfer device
98 first sucker
99 pivot axis
100 further conveying device
101 second sucker
102 piston rod
103 transfer cylinder
104 pivot arm
105 stroke mechanism
106 pivot axis
107 deposit surface
108 grip arm
109 centering gripper
110 measuring system
111 transmitter
112 receiver
113 measuring scanner
114 axis of rotation
115 piston rod
116 thrust cylinder
117 third sucker
A pivot axis (positionally regulated in angle)
B workpiece axis of rotation (positionally regulated in angle)
C workpiece axis of rotation (controlled in rotational speed)
D workpiece axis of rotation (controlled in rotational speed)
D1 blank thickness
D2 edge thickness of the semi-finished product
F1 linear axis 1st fast-tool servo (regulated in position)
F2 linear axis 2nd fast-tool servo (regulated in position)
T1 depth of groove in the front side
Y linear axis of workpiece (regulated in position)

What is claimed is:

1. A method for processing spectacle lenses (14) by machining, in which starting from a blank a semi-finished product with predetermined surface geometries at a front side (15) and a rear side (16) remote therefrom and with an edge (17) between the front side (15) and the rear side (16) is formed, comprising the following main steps taking place in the indicated sequence:
i) providing the blank which can already have the predetermined surface geometry at the front side (15) and is to be processed at least at the rear side (16);
ii) fixing and determining location and position of the blank in three dimensions;
iii) retaining block-free the blank at the rear side (16) with consideration of the location and position data, which were determined in step ii), by a workpiece holding head (10), which is arranged to be positionable in defined manner in three dimensions, for supported holding of the workpiece (14);
iv) measuring the blank, which is held by the workpiece holding head (10), at the front side (15) for detection of the front side geometry;
v) direct transfer of the workpiece (14) from the workpiece holding head (10) to a workpiece retainer (13), which is arranged to be positionable in position and angle in defined manner, for block-free retention of the workpiece (14) at the front side (15) with consideration of the front side geometry data detected in step iv) and for supported holding of the workpiece (14); and
vi) processing the workpiece (14) at the rear side (16) by at least one tool (23 24, 27) for forming the semi-finished product with the predetermined surface geometry at the rear side (16);
wherein the workpiece (14) between steps iii) and v) is held without interruption at the workpiece holding head (10) so that location and position of the workpiece (14) in three dimensions are always clearly defined.

2. A method according to claim 1, wherein, in terms of time between the step iv) of measuring the blank and the step v) of direct transfer of the workpiece (14) from the workpiece holding head (10) to the workpiece retainer (13), a processing step vii) is carried out, in which the blank held at the workpiece holding head (10) is so processed that a circumferential area defining a contoured edge (17′) of the semi-finished product to be formed remains at the workpiece (14).

3. A method according to claim 2, wherein in the processing step vii) the blank is processed at the front side (15) by a tool (35) so as to produce an encircling groove (36) or step with a depth (T1), which is larger than or equal to an edge thickness (D2) of the semi-finished product to be formed and smaller than a blank thickness (D1), or an encircling plunge cut which has at least in part a depth equal to the blank thickness (D1).

4. A method according to claim 3, wherein the workpiece (14) is measured again at the front side (15) in terms of time after the processing step vii) and before the step v) of direct transfer of the workpiece (14) from the workpiece holding head (10) to the workpiece retainer (13) so as to check location and position of the workpiece (14) at the workpiece holding head (10).

5. A method according to claim 4, wherein in the step ii) of fixing and determining location and position of the blank in three dimensions the blank after deposit on a deposit surface (107) is geometrically centered so as to fix the location of the blank, whereupon the blank is checked by an optical measuring system (110) with respect to markings so as to determine the position of the blank.

6. A method according to claim 5, wherein in the step iv) of measuring the blank, the blank held by the workpiece holding head (10) is scanned by contact so as to detect the front side geometry and/or after the processing step vii) the workpiece (14) held by the workpiece holding head (10) is scanned by contact so as to check location and position of the workpiece (14) at the workpiece holding head (10).

7. A workpiece holding head (10) for optical workpieces (14), which each have two workpiece surfaces (15, 16) and a workpiece edge (17) therebetween, particularly for use in a method according to any one of the preceding claims, comprising a housing (50) which has a center axis (51) and in or at which a holding arrangement (48) and a support arrangement (49) for a workpiece (14) to be processed are received, wherein the holding arrangement (48) has a rubber-elastic sealing sleeve (52), which is mounted on the housing (50), with a sealing lip (53) for contact with the workpiece (14) to be processed, the sealing lip encircling the center axis (51) and surrounding an opening (54) of the housing (50) to which a sub-atmospheric pressure can be applied so as to hold the workpiece (14) to be processed, and wherein the support arrangement (49) comprises a plurality of pins (55) which are longitudinally displaceable with respect to the housing (50) and can be placed against the workpiece (14) to be processed, the pins being selectively fixable with respect to the housing (50) by a clamping mechanism (56), characterized in that associated with each of the pins (55) is a pneumatically loadable piston-cylinder arrangement (57) by way of which depending on the loading of the piston-cylinder arrangement (57) the respective pin (55) is selectively movable either in a direction out of the housing (50) into a support position for the workpiece (14) to be processed or conversely in a direction into the housing (50) and into a parked position.

8. A workpiece holding head (10) according to claim 7, characterized in that in their support position (FIG. 13) the pins (55) of the support arrangement (49) project by their ends, which are remote from the housing (50), beyond the opening (54) of the housing (50) for contact with the workpiece (14) to be processed and in their parked position (FIG. 9) are retracted in the opening (54) of the housing (50) so as to avoid workpiece contact.

9. A workpiece holding head (10) according to claim 8, characterized in
that the piston-cylinder arrangements (57) associated with the pins (55) each have a piston (70) loadable at one side by way of a cylinder chamber (71) with pressure or sub-atmospheric pressure and/or
that the piston (70) of the respective piston-cylinder arrangement (57) when loaded with pressure moves the associated pin (55) into the support position and when loaded with the sub-atmospheric pressure moves the associated pin (55) into the parked position and/or
that the piston (70) of the respective piston-cylinder arrangement (57) is provided on at least one of its end faces with a buffer element (78) for end position damping and/or
that the cylinder chambers (71) of the piston-cylinder arrangements (57) can be loaded with pressure or sub-atmospheric pressure by way of a common annular space (73) in the housing (50).

10. A workpiece holding head (10) according to claim 9, characterized in that each piston (70) loadable at one side with pressure or sub-atmospheric pressure of the piston-cylinder arrangements (57) associated with the pins (55) is provided with a groove ring (76), the static sealing lip of which is secured in a radial groove of the piston (70) and the dynamic sealing lip (77) of which facing the respective cylinder chamber (71) resiliently bears against a piston running surface of the cylinder chamber (71).

11. A workpiece holding head (10) according to claim 10, characterized in
that the rubber-elastic sealing sleeve (52) of the holding arrangement (48) is formed to be circularly annular and/or
that the sealing lip (53) of the rubber-elastic sleeve (52) is chamfered radially inwardly with respect to the center axis (51) of the housing (50) and/or
that the pins (55) of the support arrangement (49) are distributed at a uniform angular spacing from one another on a common pitch circle about the center axis (51) of the housing (50) and/or
that the holding arrangement (48) and the support arrangement (49) are received in or at the housing (50) in an arrangement concentric with respect to the center axis (51) and/or
that the pins (55) of the support arrangement (49) are arranged radially within the rubber-elastic sealing sleeve (52) with respect to the center axis (51) of the housing (50).

12. A workpiece holding head (10) according to claim 11, characterized in that the sub-atmospheric pressure can be applied to the opening (54) of the housing (50) through the clamping mechanism (56) for the pins (55) of the support arrangement (49).

13. A workpiece holding head (10) according to claim 12, characterized in
that the clamping mechanism (56) has for each pin (55) of the support arrangement (49) a clamping wedge (79) which can be brought by a common actuating wedge (80) into contact with the associated pin (55) so as to clamp the respective pin (55) with respect to the housing (50) and/or
that the clamping wedges (79) are guided at the housing (50) in clamping direction and/or
that the clamping mechanism (56) is pneumatically actuable and/or
that associated with the clamping mechanism (56) is a piston-cylinder arrangement (83), the piston (84) of which is in operative connection with the actuating wedge (80) and can be pneumatically loaded on opposite sides so as to either press the clamping wedges (79) against the pins (55) of the support arrangement (49) by way of the actuating wedge (80) or relieve the clamping wedges.

14. A workpiece holding head (10) according to claim 13, characterized in
that the longitudinally displaceable pins (55) of the support arrangement (49) are cylindrical pins and/or
that the pins (55) of the support arrangement (49) are axially guided in the housing (50) over the axial length of clamping wedges (79) of the clamping mechanism (56) and/or
that each pin (55) of the support arrangement (49) is formed integrally with a piston (70) of the respectively associated piston-cylinder arrangement (57) and/or
that the ends, which are remote from the housing (50), of the pins (55) are formed to be substantially lens-shaped or are each provided with a substantially conical tip (55′) and/or
that the support arrangement (49) has between three and nine pins (55).

15. A workpiece holding head (10) according to any one of claim 14, characterized in that the housing (50) has a securing section (58) for exchangeable securing to a robot arm (47) of a multi-axis robot (12) or another handling device with corresponding positioning possibilities in three dimensions.

16. A method according to claim 2, wherein the workpiece (14) is measured again at the front side (15) in terms of time after the processing step vii) and before the step v) of direct transfer of the workpiece (14) from the workpiece holding head (10) to the workpiece retainer (13) so as to check location and position of the workpiece (14) at the workpiece holding head (10).

17. A method according to claim 1, wherein in the step ii) of fixing and determining location and position of the blank in three dimensions the blank after deposit on a deposit surface (107) is geometrically centered so as to fix the location of the blank, whereupon the blank is checked by an optical measuring system (110) with respect to markings so as to determine the position of the blank.

18. A method according to claim 1, wherein in the step iv) of measuring the blank, the blank held by the workpiece holding head (10) is scanned by contact so as to detect the front side geometry and/or after the processing step vii) the workpiece (14) held by the workpiece holding head (10) is scanned by contact so as to check location and position of the workpiece (14) at the workpiece holding head (10).

19. A workpiece holding head (10) according to claim 7, characterized in
that the piston-cylinder arrangements (57) associated with the pins (55) each have a piston (70) loadable at one side by way of a cylinder chamber (71) with pressure or sub-atmospheric pressure and/or
that the piston (70) of the respective piston-cylinder arrangement (57) when loaded with pressure moves the associated pin (55) into the support position and when loaded with the sub-atmospheric pressure moves the associated pin (55) into the parked position and/or
that the piston (70) of the respective piston-cylinder arrangement (57) is provided on at least one of its end faces with a buffer element (78) for end position damping and/or
that the cylinder chambers (71) of the piston-cylinder arrangements (57) can be loaded with pressure or sub-atmospheric pressure by way of a common annular space (73) in the housing (50).

20. A workpiece holding head (10) according to claim 19, characterized in that each piston (70) loadable at one side with pressure or sub-atmospheric pressure of the piston-cylinder arrangements (57) associated with the pins (55) is provided with a groove ring (76), the static sealing lip of which is secured in a radial groove of the piston (70) and the dynamic sealing lip (77) of which facing the respective cylinder chamber (71) resiliently bears against a piston running surface of the cylinder chamber (71).

21. A workpiece holding head (10) according to claim 7, characterized in
that the rubber-elastic sealing sleeve (52) of the holding arrangement (48) is formed to be circularly annular and/or
that the sealing lip (53) of the rubber-elastic sleeve (52) is chamfered radially inwardly with respect to the center axis (51) of the housing (50) and/or
that the pins (55) of the support arrangement (49) are distributed at a uniform angular spacing from one another on a common pitch circle about the center axis (51) of the housing (50) and/or
that the holding arrangement (48) and the support arrangement (49) are received in or at the housing (50) in an arrangement concentric with respect to the center axis (51) and/or
that the pins (55) of the support arrangement (49) are arranged radially within the rubber-elastic sealing sleeve (52) with respect to the center axis (51) of the housing (50).

22. A workpiece holding head (10) according to claim 7, characterized in that the sub-atmospheric pressure can be applied to the opening (54) of the housing (50) through the clamping mechanism (56) for the pins (55) of the support arrangement (49).

23. A workpiece holding head (10) according to claim 7, characterized in
that the clamping mechanism (56) has for each pin (55) of the support arrangement (49) a clamping wedge (79) which can be brought by a common actuating wedge (80) into contact with the associated pin (55) so as to clamp the respective pin (55) with respect to the housing (50) and/or
that the clamping wedges (79) are guided at the housing (50) in clamping direction and/or
that the clamping mechanism (56) is pneumatically actuable and/or
that associated with the clamping mechanism (56) is a piston-cylinder arrangement (83) the piston (84) of which is in operative connection with the actuating wedge (80) and can be pneumatically loaded on opposite sides so as to either press the clamping wedges (79) against the pins (55) of the support arrangement (49) by way of the actuating wedge (80) or relieve the clamping wedges.

24. A workpiece holding head (10) according to claim 7, characterized in
that the longitudinally displaceable pins (55) of the support arrangement (49) are cylindrical pins and/or
that the pins (55) of the support arrangement (49) are axially guided in the housing (50) over the axial length of clamping wedges (79) of the clamping mechanism (56) and/or
that each pin (55) of the support arrangement (49) is formed integrally with a piston (70) of the respectively associated piston-cylinder arrangement (57) and/or
that the ends, which are remote from the housing (50), of the pins (55) are formed to be substantially lens-shaped or are each provided with a substantially conical tip (55′) and/or
that the support arrangement (49) has between three and nine pins (55).

25. A workpiece holding head (10) according to claim 7, characterized in that the housing (50) has a securing section (58) for exchangeable securing to a robot arm (47) of a multi-axis robot (12) or another handling device with corresponding positioning possibilities in three dimensions.
